(19) United States
(12) Patent Application Publication
(10) Pub. No.: US 2026/0094022 A1
(43) Pub. Date: Apr. 2, 2026

(54) MANAGING UNTRAINING OF INFERENCE MODELS WITH RESPECT TO PORTIONS OF TRAINING DATA

(71) Applicant: Dell Products L.P., Round Rock, TX (US)

(72) Inventors: OFIR EZRIELEV, Be'er Sheva (IL); JEHUDA SHEMER, Kfar Saba (IL); ONUR CELEBIOGLU, Austin, TX (US)

(21) Appl. No.: 18/899,074

(22) Filed: Sep. 27, 2024

(51) Int. Cl. G06N 5/04

(52) U.S. Cl. CPC G06N 5/04

(57) ABSTRACT

Methods and systems for providing computer-implemented services using inference models are disclosed. To provide the computer-implemented services, a prototype inference model may be untrained with respect to a portion of training data that has sensitive and/or poisoned information content. To do so, a first partial untraining procedure may be performed to obtain a partially untrained prototype inference model. A testing procedure may be performed using a trusted inference model to determine whether the partially untrained prototype inference model has been sufficiently untrained with respect to the portion of training data and is sufficiently trained with respect to other training data that has an information content that is to be retained. If these conditions are met, the partially untrained prototype inference model may be promoted to a production ready inference model and used to provide the computer-implemented services.

### FIELD

Embodiments disclosed herein relate generally to managing inference models. More particularly, embodiments disclosed herein relate to systems and methods to manage untraining of inference models for a portion of training data.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a block diagram illustrating a system in accordance with an embodiment.

FIGS. 2A-2G show diagrams illustrating data flows in accordance with an embodiment.

FIG. 2H shows a diagram illustrating a prototype inference model in accordance with an embodiment.

FIGS. 3A-3D show flow diagrams illustrating a method for providing computer-implemented services using inference models in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for providing computer-implemented services using inference models. An inference model may be a generative artificial intelligence (AI) model (e.g., a large language model (LLM)) and may generate responses when provided with prompts. The responses may be used, at least in part, to provide the computer-implemented services. However, a quality of the computer-implemented services may be impacted by the knowledge base of the inference model.

For example, the knowledge base of the inference model may include sensitive (e.g., private, confidential, proprietary) information and/or poisoned information (e.g., false information generated by a malicious entity). Use of the inference model with the knowledge base may increase a likelihood of exposure of the sensitive information and/or unauthorized use of the sensitive information (e.g., due data privacy restrictions). In addition, inferences (e.g., responses) based on the poisoned information may also be poisoned. Therefore, it may be desirable to reduce the inference model's ability to generate inferences based on the sensitive and/or poisoned information.

To reduce the inference model's ability to generate inferences based on the sensitive and/or poisoned information, an untraining procedure (e.g., an untraining process) may be performed for the inference model. The inference model may be referred to henceforth as a prototype inference model. The untraining procedure may include multiple cycles of untraining using any method followed by optimization and evaluation (e.g., testing) processes until it is determined (e.g., by a subject matter expert (SME)) that the sensitive information has been sufficiently removed from the knowledge base and, therefore, the inference model is deemed production ready.

However, the untraining, optimization, and/or evaluation processes used to obtain the production ready inference model may be repeated any number of times and with any quantity of training data until the SME (and/or another entity) determines whether the prototype inference model is approved for use in providing the computer-implemented services (e.g., is production ready). Doing so may consume an undesirable quantity of resources (e.g., computational resources, time resources, cognitive resources of the SME). In addition, the production ready inference model may continue to be updated over time (e.g., may be replaced with a second production ready inference model, may be at least partially modified). To update the production ready inference model, the training, optimization, and/or evaluation processes may be repeated, thereby consuming additional resources that may otherwise be allocated to providing the computer-implemented services. Consequently, the computer-implemented services may be delayed, interrupted, and/or may otherwise be negatively impacted.

To reduce resource expenditure during obtaining a production ready inference model, evaluation of a knowledge base of a prototype inference model may be performed during untraining. To do so, a second inference model (e.g., a copy of the prototype inference model prior to untraining) may be used to assess a partially untrained prototype inference model's ability to generate desired (e.g., consistent and accurate) responses to a first set of prompts intended to elicit responses based on the sensitive and/or poisoned information. The partially untrained prototype inference model may be the prototype inference model following a first partial untraining procedure. Following the first partial untraining procedure, the partially untrained prototype inference model may have a reduced ability to generate the desired responses to the first set of prompts.

If the partially untrained prototype inference model's ability to generate the desired responses to the first set of prompts is reduced to a degree considered acceptable, a second assessment may be performed using the second inference model. The second assessment may include testing an ability of the partially untrained prototype inference model to generate desired responses to other prompts (e.g., a second set of prompts). The second set of prompts may be intended to elicit responses based on other information content that is desired to be retained with the knowledge base of the partially untrained prototype inference model. Therefore, if the partially untrained prototype inference model generates the desired responses (e.g., to a degree considered acceptable) to the second set of prompts, the untraining procedure may not continue and the partially untrained prototype inference model may be used as an updated prototype inference model. The updated prototype inference model may be promoted to a production ready inference model and the production ready inference model may then be used as part of providing computer-implemented services.

Thus, embodiments disclosed herein may address, among other technical problems, the technical challenge of evaluating when a partially untrained prototype inference model has been sufficiently untrained on a portion of training data that includes sensitive and/or poisoned information content while being sufficiently trained on other training data. By evaluating the knowledge base of the partially untrained prototype inference model during training, a resource expenditure during untraining and/or evaluation may be reduced (e.g., by not consuming additional resources to further untrain the partially untrained prototype inference model once performance criteria are met). Consequently, a likelihood of providing computer-implemented services to downstream consumers as desired may be increased.

In an embodiment, a method for providing computer-implemented services using inference models is disclosed. The method may include: identifying that a portion of training data used to train a prototype inference model has an information content that is to be removed from a knowledge base of the prototype inference model, the prototype inference model also having other information content based on other training data of the training data that is to be retained with the knowledge base of the prototype inference model; initiating performance of an untraining procedure for the prototype inference model using at least the portion of the training data, a first set of prompts based on the portion of the training data, and a second set of prompts based on the other training data of the training data until performance criteria are met to obtain an updated prototype inference model, the performance criteria being usable to identify when the untraining procedure is complete and the performance criteria defining at least a first level of ability of the updated prototype inference model to utilize the information content to generate desirable responses to the first set of prompts and a second level of ability of the updated prototype inference model to utilize the other information content to generate desirable responses to the second set of prompts; in a first instance of the initiating in which the performance criteria are met: promoting the updated prototype inference model to a production ready inference model; and using the production ready inference model to provide the computer-implemented services.

Initiating performance of the untraining procedure may include: performing, using the training data, a first partial untraining procedure for the prototype inference model to obtain a partially untrained prototype inference model; performing, using the prototype inference model, a first testing procedure to determine whether the partially untrained prototype inference model provides inconsistent responses to the first set of prompts; in a first instance of the performing the first testing procedure in which the partially untrained prototype inference model provides the inconsistent responses: performing a second testing procedure to determine whether the partially untrained prototype inference model provides consistent and accurate responses to the second set of prompts; in a first instance of the performing the second testing procedure in which the partially untrained prototype inference model provides the consistent and accurate responses to the second set of prompts: concluding that the partially untrained prototype inference model meets the performance criteria to obtain the updated prototype inference model.

The method may also include: in a second instance of the performing the first testing procedure in which the partially untrained prototype inference model does not provide the inconsistent responses to the first set of prompts: performing a second partial untraining procedure for the partially untrained prototype inference model to obtain a further partially untrained prototype inference model.

Performing the first testing procedure may include: obtaining, using the first set of prompts, a first set of responses from the partially untrained prototype inference model, the first set of responses including: a first response to a first prompt of the first set of prompts; and a second response to a second prompt of the first set of prompts; performing a response agreement testing process to obtain a level of agreement between at least the first response and the second response; making a determination regarding whether the level of agreement meets agreement criteria; in a first instance of the determination in which the level of agreement meets the agreement criteria: concluding that the partially untrained prototype inference model provides the inconsistent responses to the first set of prompts; and in a second instance of the determination in which the level of agreement does not meet the agreement criteria: concluding that the partially untrained prototype inference model does not provide the inconsistent responses to the first set of prompts.

Providing the inconsistent responses to the first set of prompts may indicate that a second knowledge base of the partially untrained prototype inference model does not have the information content.

Performing the second testing procedure may include: performing a first attempting to verify that the partially untrained prototype inference model provides the consistent responses to the second set of prompts; in a first instance of the first attempting where the partially untrained prototype inference model provides the consistent responses: performing, using the second set of prompts, a second attempting to verify that the partially untrained prototype inference model provides the accurate responses to the second set of prompts.

Performing the first attempting may include: obtaining, using the second set of prompts, a second set of responses from the partially untrained prototype inference model, the second set of responses including a first response to a first prompt of the second set of prompts and a second response to a second prompt of the second set of prompts; performing a second response agreement testing process to obtain a second level of agreement between at least the first response and the second response; making a determination regarding whether the second level of agreement meets agreement criteria; in a first instance of the determination in which the second level of agreement meets the agreement criteria: concluding that the partially untrained prototype inference model provides the consistent responses to the second set of prompts; and in a second instance of the determination in which the second level of agreement does not meet the agreement criteria: concluding that the partially untrained prototype inference model does not provide the consistent responses to the second set of prompts.

Performing the second attempting may include: comparing a first information content of the consistent responses to the other information content of the other training data to obtain a level of similarity between the first information content and the other information content; making a second determination regarding whether the level of similarity meets a level of similarity threshold; in a first instance of the second determination in which the level of similarity meets the level of similarity threshold: concluding that the partially untrained prototype inference model provides the accurate responses to the second set of prompts; and in a second instance of the second determination in which the level of similarity does not meet the level of similarity threshold: concluding that the partially untrained prototype inference model does not provide the accurate responses to the second set of prompts.

Providing the consistent and accurate responses to the second set of prompts may indicate that a second knowledge base of the partially untrained prototype inference model has the other information content.

The prototype inference model may be a generative artificial intelligence (AI) model.

The prototype inference model may provide consistent and accurate responses to the first set of prompts and the second set of prompts.

In an embodiment, a non-transitory media is provided that may include instructions that when executed by a processor cause the computer-implemented method to be performed.

In an embodiment, a data processing system is provided that may include the non-transitory media and a processor, and may perform the computer-implemented method when the computer instructions are executed by the processor.

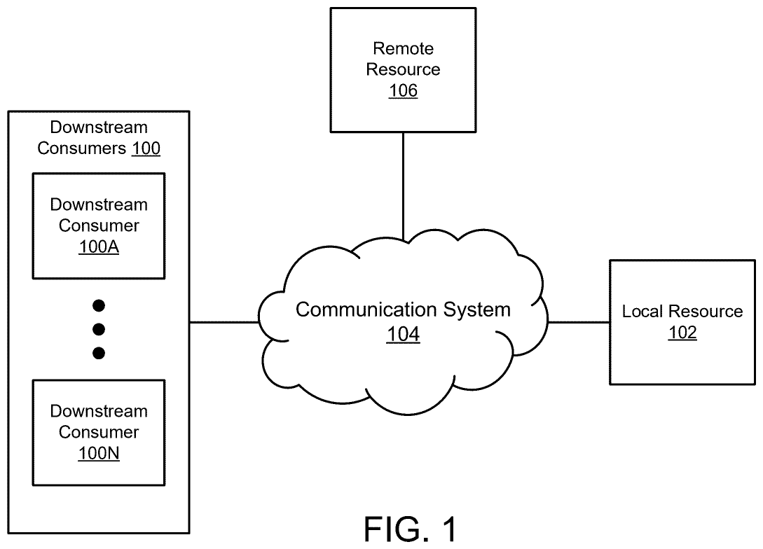

Turning to FIG. 1, a block diagram illustrating a system in accordance with an embodiment is shown. The system shown in FIG. 1 may provide computer-implemented services. The computer-implemented services may include any type and quantity of computer-implemented services. For example, the computer-implemented services may include data storage services, instant messaging services, database services, data generation services, and/or any other type of service that may be implemented with a computing device. The computer-implemented services may be provided, at least in part, using inference models and/or inferences (e.g., responses) obtained using the inference models.

To obtain the responses used to provide the computer-implemented services, the inference models may be trained, using training data, to generate the responses when provided with prompts (e.g., ingest data). The inference models may include generative artificial intelligence (AI) inference models (e.g., large language models (LLMs)); therefore, the responses may include new instances of data created by the generative AI inference models based on learned associations from and/or an understanding of the training data. For example, the inference models may be trained using unstructured data, such as stories, essays, audio transcription, video description, and/or other types of human interpretable text, to generate responses of the same.

For example, a prototype inference model may be trained using a set of training data to have a knowledge base. The prototype inference model may obtain prompts based on the set of training data and may generate responses used to provide the computer-implemented services using the knowledge base. However, at least a portion of the training data may be determined to be based on sensitive (e.g., private, proprietary, confidential) information and/or may be poisoned (e.g., may include relationships established by a malicious entity that are false, untrustworthy, and/or conspiratorial). The sensitive and/or poisoned information may be unsuitable for use in generating the responses. The sensitive and/or poisoned information may be unsuitable for use in generating the responses due to a risk of exposure of the sensitive information, due to data privacy regulations that limit the use of certain information content when providing the computer-implemented services to downstream consumers, and/or due to other reasons.

For example, the prototype inference model may be trained locally (e.g., by a local resource) and may be operated at a remote location (e.g., by a remote resource). The training data used to train the prototype inference model may include proprietary information related to a business and/or other entity. The local resource may be trusted to access the proprietary information. However, the remote resource may not be trusted to access the proprietary information (e.g., due to differing data privacy regulations, due to network security concerns). In addition, downstream consumers of the computer-implemented services may not be trusted to access the proprietary information.

To reduce a likelihood of exposure of the sensitive information (e.g., during operation of the prototype inference model, based on inferences generated by the prototype inference model), the prototype inference model may be untrained with respect to a portion of the training data that has a sensitive information content. To untrain the prototype inference model, untraining, optimization, and/or evaluation processes may be performed (e.g., by the local resource, by another entity trusted by the local resource). During the untraining, optimization, and/or evaluation processes, the prototype inference model may undergo untraining using at least a portion of the training data followed by optimization and evaluation processes until it is determined whether an untrained prototype inference model has been sufficiently untrained with respect to the portion of the training data (e.g., by a SME). If the untrained prototype inference model is deemed sufficiently untrained, the untrained prototype inference model may be promoted to a production ready inference model.

However, the untraining, optimization, and/or evaluation processes used to obtain the production ready inference model may be repeated any number of times and with any quantity of training data until the SME (and/or another entity) determines that the untrained prototype inference model is approved for use in providing the computer-implemented services (e.g., is production ready). For example, the prototype inference model may undergo any number of de-optimization cycles (e.g., using methods such as gradient ascent with respect to inference error) until the SME deems the untrained prototype inference model production ready.

Doing so may consume an undesirable quantity of resources (e.g., computational resources, time resources, cognitive resources of the SME). In addition, the production ready inference model may continue to be updated over time (e.g., may be replaced with a second production ready inference model, may be at least partially modified). To update the production ready inference model, the untraining, optimization, and/or evaluation processes may be repeated, thereby consuming additional resources that may otherwise be allocated to providing the computer-implemented services. Consequently, the computer-implemented services may be delayed, interrupted, and/or may otherwise be negatively impacted.

In general, embodiments disclosed herein may provide methods, systems, and/or devices for determining when a prototype inference model has been sufficiently untrained on a portion of training data using a second inference model. By using the second inference model (e.g., a trusted inference model previously deemed consistent and accurate) to determine when to stop untraining the prototype inference model, a likelihood of providing computer-implemented services in a desired manner may be increased while conserving resources consumed during untraining, optimization, and/or evaluation processes of the prototype inference model.

To do so, a production ready inference model may be obtained based on prototype inference model. The production ready inference model and the prototype inference model may be generative AI models (e.g., large language models (LLMs)). The prototype inference model may have a knowledge base based on a set of training data. The training data may include: (i) a portion of the training data that has an information content desired to be removed from a knowledge base of the prototype inference model (e.g., the sensitive and/or poisoned information), and (ii) other training data that has other information content that is to be retained with the knowledge base of the prototype inference model.

The production ready inference model may be intended to have a reduced knowledge base with respect to the portion of the training data when compared to the knowledge base of the prototype inference model. By using the production ready inference model as part of providing the computer-implemented services, a quality, type, and/or other characteristic of the computer-implemented services may be improved at least in part by reducing a likelihood of exposure and/or unauthorized use of the sensitive and/or poisoned information.

To obtain the production ready inference model used in the provision of the computer-implemented services, a first partial untraining procedure may be performed for a prototype inference model to obtain a partially untrained prototype inference model. A first testing procedure may then be performed (e.g., using the prototype inference model, using another trusted LLM) using a first set of prompts to determine whether the partially untrained prototype inference model provides inconsistent responses to the first set of prompts. The first set of prompts may be obtained (e.g., from a SME, from a third inference model) based on the portion of the training data that includes the sensitive and/or poisoned information. Therefore, if the partially untrained prototype inference model provides the inconsistent responses to the first set of prompts, it may be determined that the partially untrained prototype inference model is sufficiently untrained with respect to the portion of the training data.

If the partially untrained prototype inference model provides the inconsistent responses to the first set of prompts, a second testing procedure may be performed (e.g., using the prototype inference model, using another trusted inference model) using a second set of prompts to determine whether the partially untrained prototype inference model provides consistent and accurate responses to the second set of prompts. The second set of prompts may be obtained (e.g., from a SME, from a third inference model) based on the other training data of the training data that is to be retained with the knowledge base. Therefore, if the partially untrained prototype inference model provides the consistent and accurate responses to the second set of prompts, it may be determined that the partially untrained inference model is sufficiently trained with respect to the other training data.

If the responses generated by the partially untrained prototype inference model to the second set of prompts are deemed consistent and accurate (e.g., by the prototype inference model, by another trusted inference model), it may be determined that performance criteria are met, and the partially untrained prototype inference model may be used as an updated prototype inference model.

The performance criteria may be usable to identify when the untraining procedure is complete and may define a first level of ability of the updated prototype inference model to utilize the sensitive and/or poisoned information to generate desirable (e.g., consistent and/or accurate) responses to the first set of prompts and a second level of ability of the updated prototype inference model to utilize other information content (e.g., of the other training data) to generate desirable responses to the second set of prompts. Once the performance criteria are met, the updated prototype inference model may be promoted to the production ready inference model and used to provide the computer-implemented services.

If the partially untrained prototype inference model does not meet the performance criteria, a second partial untraining procedure for the partially untrained prototype inference model may be performed. The partially untrained prototype inference model may continue to undergo iterative cycles of untraining and testing until the performance criteria are met.

By doing so, embodiments disclosed herein may improve processes of evaluating knowledge bases of inference models so that responses generated by the inference models may have an increased likelihood of being trustworthy for use in providing computer-implemented services to downstream consumers. By evaluating the knowledge base of a prototype inference model during untraining using a second inference model, a resource expenditure during untraining and/or evaluation may be reduced. The resource expenditure may be reduced by not continuing to untrain the partially untrained prototype inference model after the partially untrained prototype inference model is sufficiently untrained on sensitive and/or poisoned information while retaining other information to provide responses as desired by a consumer of the computer-implemented services.

To provide the above noted functionality, the system of FIG. 1 may include downstream consumers 100, local resource 102, remote resource 106, and communication system 104. Each of these components is discussed below.

Downstream consumers 100 may provide and/or consume all, or a portion of, the computer-implemented services. Downstream consumers 100 may include any number of downstream consumers (e.g., 100A, 100N) and may include, for example, businesses, individuals, and/or devices (e.g., data processing systems) that may obtain responses and/or other information based on the responses as part of receiving the computer-implemented services.

Downstream consumers 100 may subscribe to computer-implemented services provided, at least in part, by local resource 102 and local resource 102 may interact with any number of other entities (e.g., remote resource 106) as part of providing the computer-implemented services. For example, remote resource 106 may provide inferencing services to local resource 102 and local resource 102 may use inferences (e.g., responses) generated by inference models hosted by remote resource 106 as part of the computer-implemented services provided to downstream consumers 100. Local resource 102 may also host inference models locally which may provide the responses used by local resource 102 in the provision of the computer-implemented services.

Remote resource 106 may manage any number of inference models and may be owned by a second owner (e.g., a third-party entity). For example, remote resource 106 may train, and/or host (e.g., operate) generative AI models and may provide inferencing services to any number of other entities. However, the inference models (e.g., the generative AI models) may be updated (e.g., retrained, untrained) over time to improve a quality of the computer-implemented services (e.g., by remote resource 106, by local resource 102). To do so, untraining and/or evaluation processes for the inference models may be performed prior to providing computer-implemented services based on responses received from the inference models.

Local resource 102 may include any entity that provides, at least in part, computer-implemented services to downstream consumers 100. Local resource 102 may be owned by a first owner. The first owner may not control remote resource 106, and/or local resource 102 and remote resource 106 may be controlled by a single entity (e.g., the first owner and the second owner may be the same entity). To provide its functionality, local resource 102 may: (i) train (e.g., using training data, using supplemental training data, using other training data), untrain, and/or host any number of inference models, (ii) perform consistency evaluations of inference models to determine whether the inference models provide consistent responses to a set of prompts, (iii) perform accuracy evaluations of inference models to determine whether the inference models provide accurate responses to the set of prompts (e.g., indicating the inference models have a desired knowledge base), and/or (iv) perform other actions.

For example, local resource 102 may perform consistency and/or accuracy evaluations during inference model training and/or untraining procedures to determine whether prototype inference models are to be promoted to production ready inference models (e.g., an inference model usable to provide the computer-implemented services as desired). The prototype inference models may include inference models trained, at least in part, using a set of training data that may include sensitive and/or poisoned information. The prototype inference models may be deemed consistent and accurate (e.g., may generate responses with a same information content to prompts intended to elicit the same information content). Prior to using the prototype inference models for providing the computer-implemented services, an untraining procedure may be initiated to reduce a prototype inference model's ability to utilize the sensitive and/or poisoned information while generating responses to prompts.

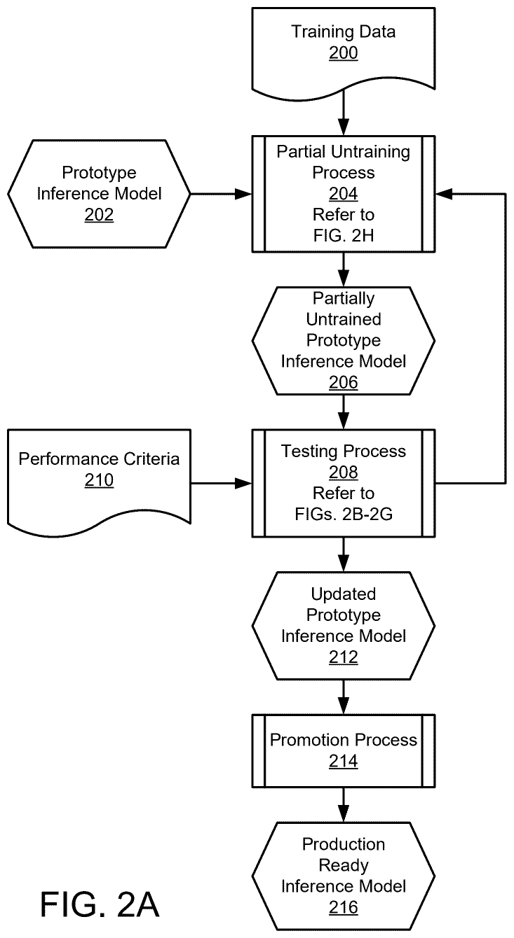

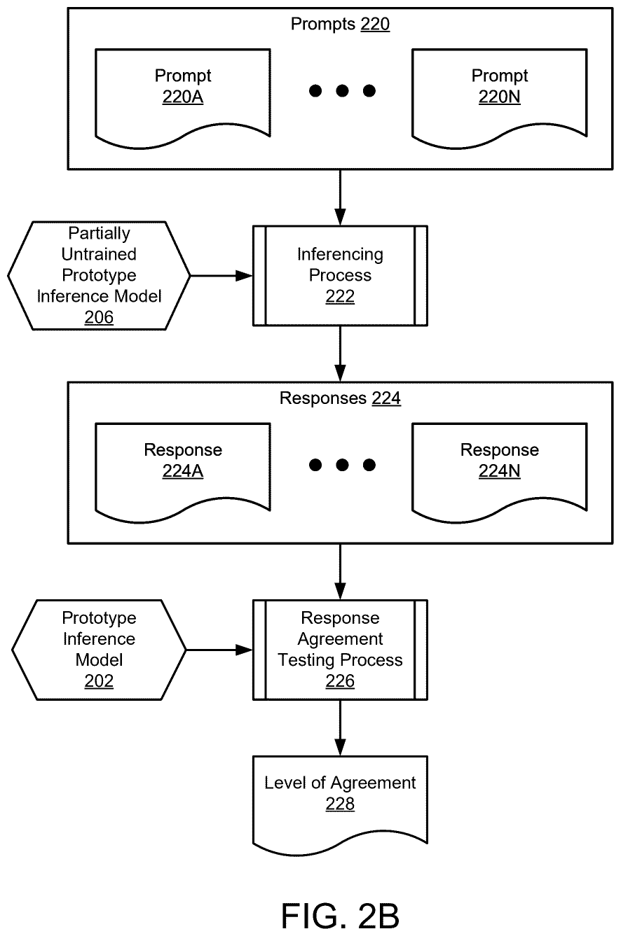

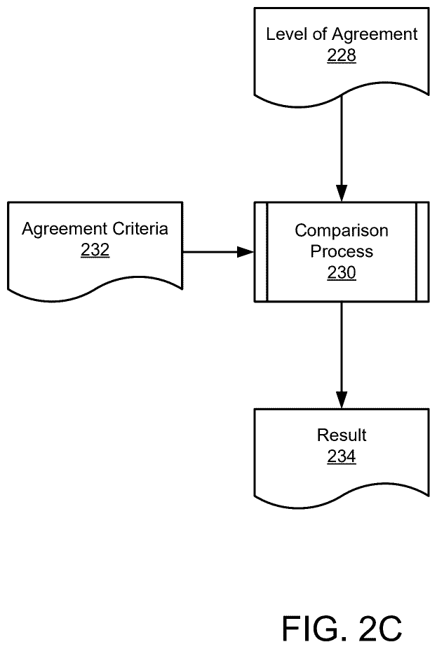

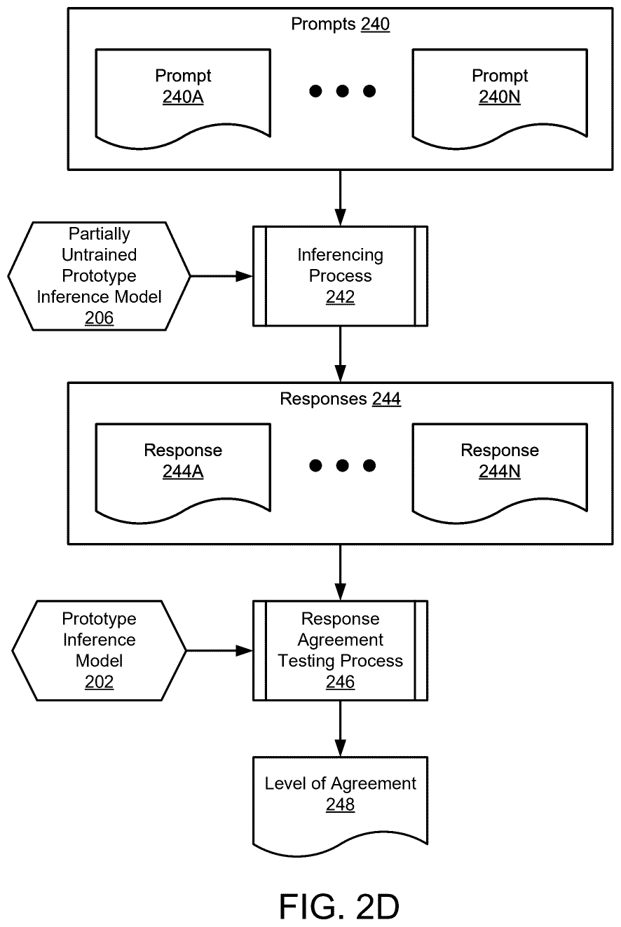

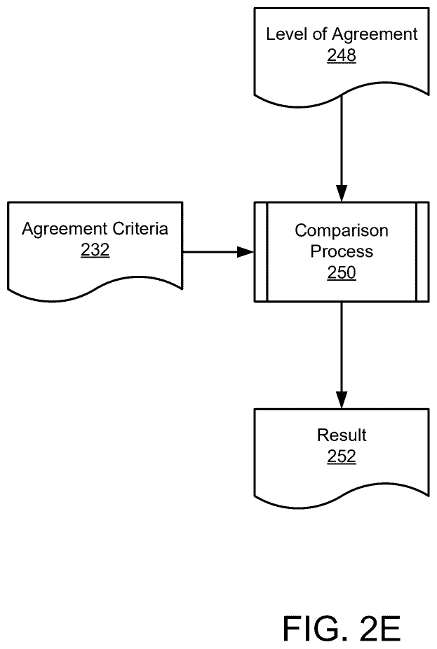

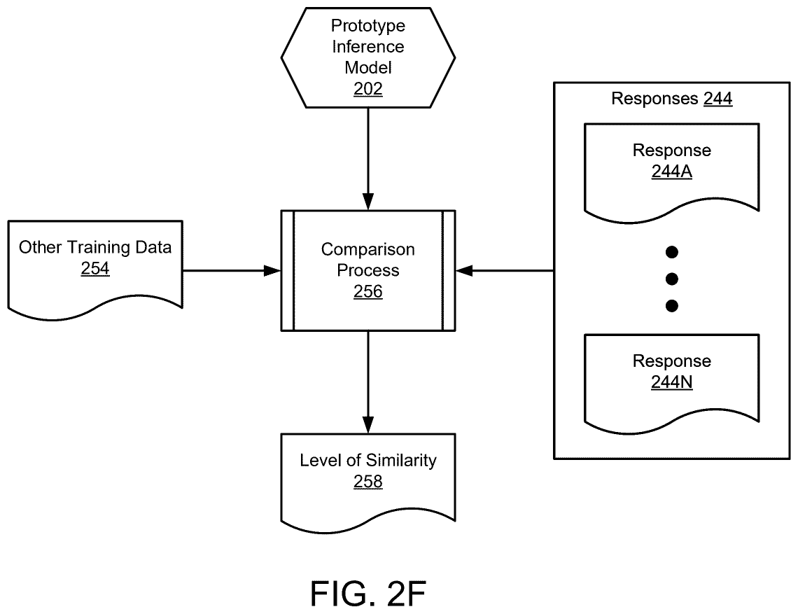

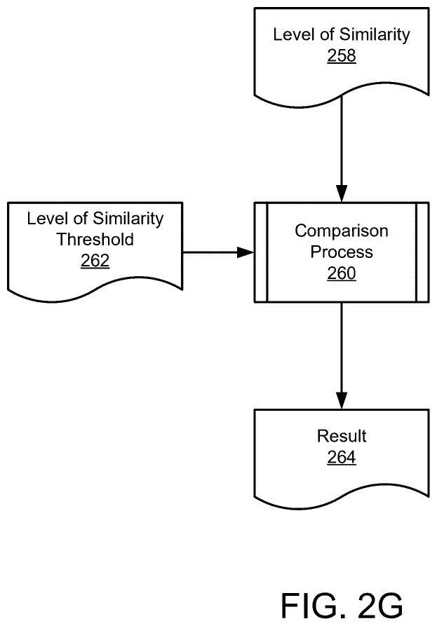

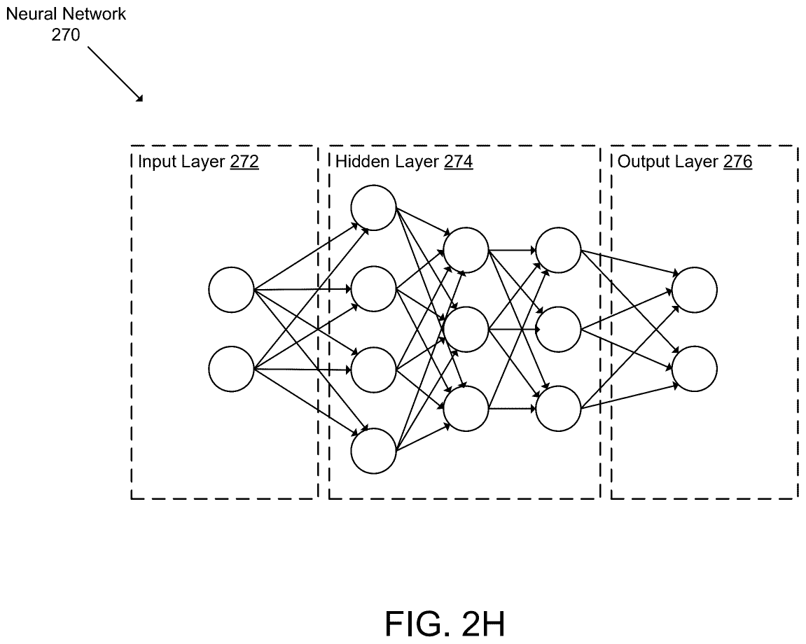

Performing the untraining procedures may include performing partial untraining procedures. Performing a first partial untraining procedure may include modifying weights of an architecture of the prototype inference model to obtain a partially untrained prototype inference model until responses generated by the partially untrained prototype inference model are not based on the information content of the sensitive information (e.g., to an extent considered acceptable based on criteria such as performance criteria). Refer to FIG. 2H for additional information regarding untraining procedures.

A partially untrained prototype inference model may be obtained as a result of the first partial untraining procedure. Local resource 102 may perform, using the prototype inference model (e.g., a copy of the prototype inference model prior to the first partial untraining procedure) and/or another trusted model, a first testing procedure to determine whether the partially untrained prototype inference model provides inconsistent responses to a first set of prompts (e.g., based on the information content of the portion of the training data). Refer to FIGS. 2B-2C for additional details regarding performing the first testing procedure.

If the partially untrained prototype inference model provides the inconsistent responses, local resource 102 may perform, using the prototype inference model and/or another trusted model, a second testing procedure to determine whether the partially untrained prototype inference model provides consistent and accurate responses to a second set of prompts (e.g., based on the other information content of the other training data). Refer to FIGS. 2D-2G for additional details regarding performing the second testing procedure.

If the partially untrained prototype inference model provides the consistent and accurate responses to the second set of prompts, local resource 102 may conclude that the partially untrained prototype inference model meets the performance criteria to obtain the updated prototype inference model. The updated prototype inference model may be promoted to the production ready inference model and used to provide the computer-implemented services.

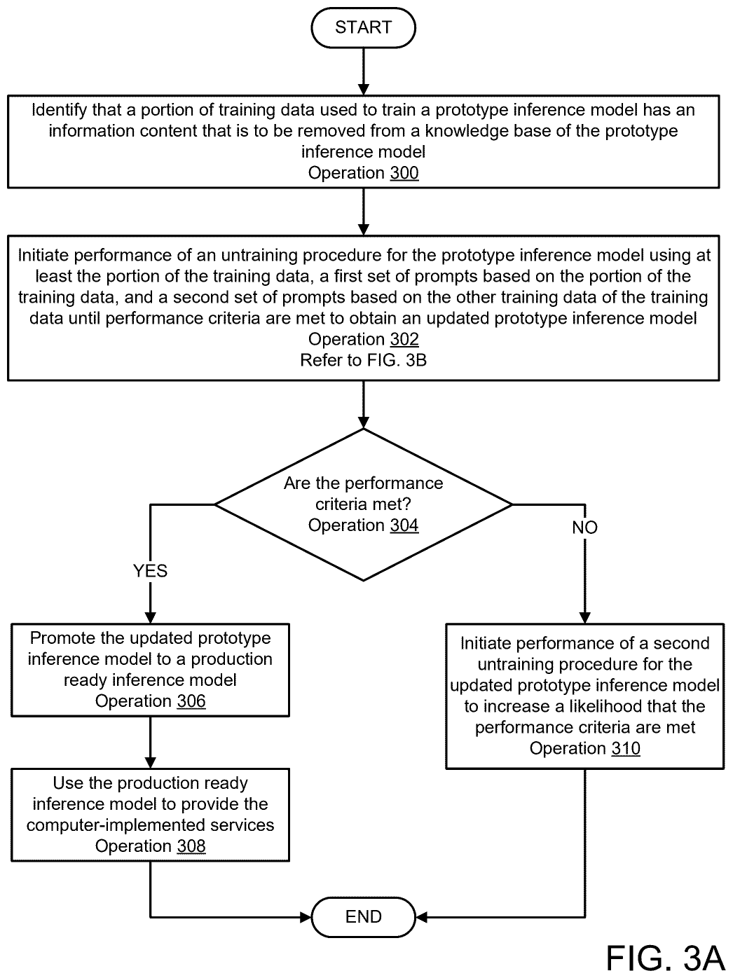

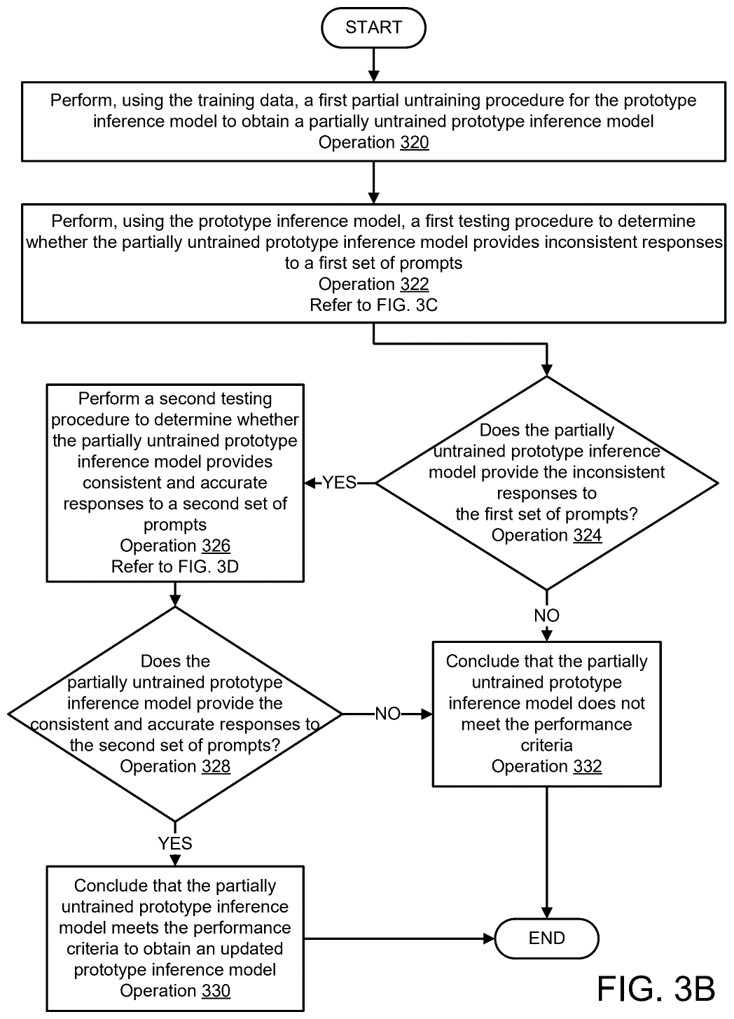

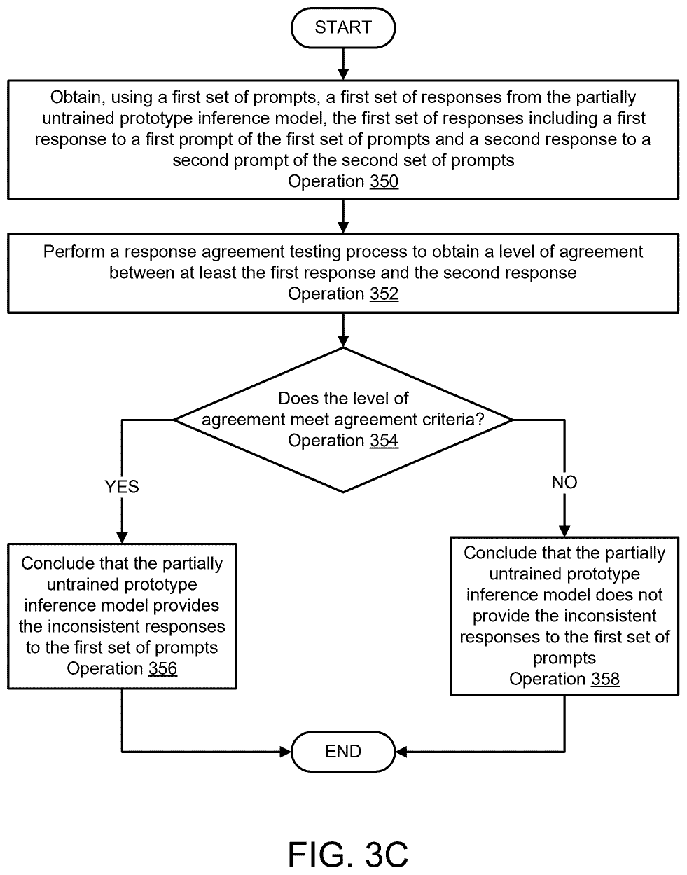

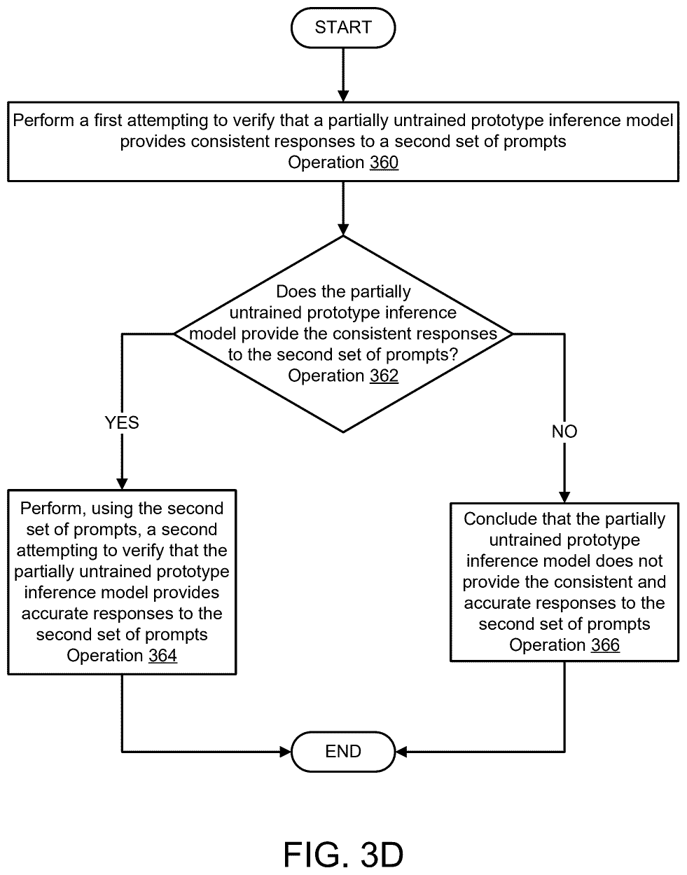

When providing their functionality, any of (and/or components thereof) downstream consumers 100, local resource 102, and/or remote resource 106 may perform all, or a portion, of the actions and methods illustrated in FIGS. 2A-3D.

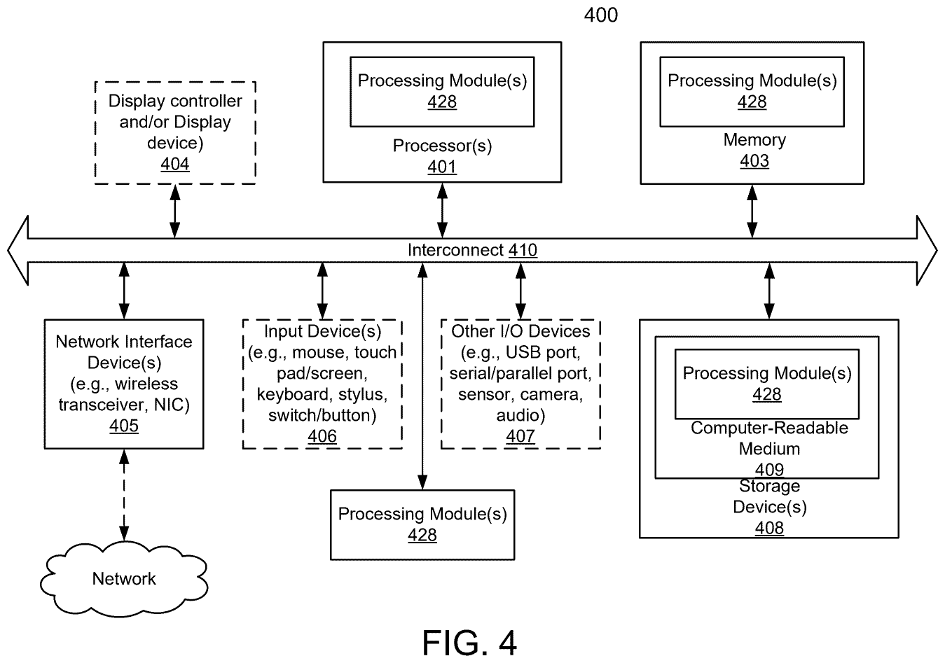

Any of (and/or components thereof) downstream consumers 100, local resource 102, and remote resource 106 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to the discussion of FIG. 4.

Any of the components illustrated in FIG. 1 may be operably connected to each other (and/or components not illustrated) with communication system 104. In an embodiment, communication system 104 includes one or more networks that facilitate communication between any number of components. The networks may include wired networks and/or wireless networks (e.g., and/or the Internet). The networks may operate in accordance with any number and types of communication protocols (e.g., such as the internet protocol).

While illustrated in FIG. 1 as including a limited number of specific components, a system in accordance with an embodiment may include fewer, additional, and/or different components than those illustrated therein.

The system described in FIG. 1 may be used to manage inference models to improve availability and/or quality of computer-implemented services provided to downstream consumers of the computer-implemented services. The following processes described in FIGS. 2A-2G may be performed by the system in FIG. 1 when providing this functionality.

To further clarify embodiments disclosed herein, data flow diagrams in accordance with an embodiment are shown in FIGS. 2A-2G. In these diagrams, flows of data and processing of data are illustrated using different sets of shapes. A first set of shapes (e.g., 200, 210, etc.) is used to represent data structures, a second set of shapes (e.g., 204, 208, etc.) is used to represent processes performed using and/or that generate data, and a third set of shapes (e.g., 202, 206) is used to represent inference models.

Turning to FIG. 2A, a first data flow diagram in accordance with an embodiment is shown. The first data flow diagram may illustrate data used in and data processing performed in obtaining a production ready inference model (e.g., production ready inference model 216) based on an existing inference model (e.g., prototype inference model 202).

To obtain production ready inference model 216, partial untraining process 204 may be initiated for prototype inference model 202 using at least a portion of training data 200. Training data 200 may include any type and/or quantity of training data usable to train and/or untrain inference models. Training data 200 may include: (i) a portion of training data 200 that has an information content that is to be removed from a knowledge base of prototype inference model 202, and (ii) other training data of training data 200 that has other information content that is to be retained with the knowledge base of prototype inference model 202. The portion of the training data that is to be removed may include sensitive information (e.g., proprietary information, private information, confidential information) and/or poisoned information (e.g., incorrect information, untrustworthy information, conspiratorial information), and it may be determined (e.g., by a downstream consumer, by an owner of a local resource responsible for training prototype inference model 202, by another entity), that the sensitive and/or poisoned information is to be removed from the knowledge base of prototype inference model 202. Removing the portion of the training data may reduce a likelihood that the information content of the portion (e.g., the sensitive information, the poisoned information) may be exposed and/or used in an unauthorized manner.

Prototype inference model 202 may be a generative AI model (e.g., an LLM) trained to generate language, understand language, and/or otherwise process requests related to languages. The generative AI model may include, for example, a neural network inference model. Prototype inference model 202 may have been previously trained using training data 200 using any training process (e.g., a global optimization process using gradient descent), training data 200 indicating goals for outputs generated by prototype inference model 202 (e.g., responses). Parameters of prototype inference model 202 may be selected using an optimization process (e.g., an objective function may be defined in terms of training data 200 and responses generated by prototype inference model 202, and a global optimization method such as gradient descent may be used to identify parameters that most faithfully reproduce the trends in training data 200). Once the parameters of prototype inference model 202 are set, then prototype inference model 202 may be used to generate responses based on input data (e.g., prompts).

Prototype inference model 202 may be trained using other methods without departing from embodiments disclosed herein.

Prototype inference model 202 may be deemed consistent and correct and, therefore, may be trusted for use in testing consistency and/or accuracy of partially untrained inference models. An inference model may be deemed consistent, for example, when a set of responses generated by the inference model (e.g., when provided with a set of prompts intended to elicit a first same information content) have a second same information content (e.g., to an extent considered acceptable based on any criteria). However, the inference model may be deemed accurate when the second same information content matches (e.g., within a threshold) the first information content.

During partial untraining process 204, weights, biases, and/or other characteristics of prototype inference model 202 may be modified to reduce prototype inference model 202's ability to generate responses to prompts based on the portion of training data 200 (e.g., via a gradient ascent process with respect to inference error for an objective function used during untraining). Refer to FIG. 2H for additional details regarding the partial untraining procedure. Partial untraining process 204 may include any other untraining process without departing from embodiments disclosed herein.

As a result of partial untraining process 204, partially untrained prototype inference model 206 may be obtained. Partially untrained prototype inference model may be a generative AI model (e.g., an LLM) trained to generate language, understand language, and/or otherwise process requests related to languages. The generative AI model may include, for example, a neural network inference model.

To determine whether partially untrained prototype inference model 206 is sufficiently untrained with respect to the portion of training data 200 while being sufficiently trained on the other training data of training data 200, testing process 208 may be performed.

During testing process 208, a first testing procedure and a second testing procedure may be performed to determine whether performance criteria 210 are met. Performance criteria 210 may, therefore, be usable to identify when untraining is complete. During the first testing procedure, it may be determined whether partially untrained prototype inference model 206 provides inconsistent responses to a first set of prompts based on the portion of training data 200. To do so, prototype inference model 202 and/or another trusted inference model (e.g., another LLM) may be used. Refer to FIGS. 2B-2C for additional details regarding the first testing procedure.

If partially untrained prototype inference model 206 provides the inconsistent responses to the first set of prompts, the second testing procedure may be performed. During the second testing procedure, it may be determined whether partially untrained prototype inference model 206 provides consistent and accurate responses to a second set of prompts based on the other training data of training data 200. To do so, prototype inference model 202 and/or another trusted inference model (e.g., another LLM) may be used. Refer to FIGS. 2D-2G for additional details regarding the second testing procedure.

Prototype inference model 202 may provide consistent and accurate responses to the first set of prompts and the second set of prompts (e.g., via being deemed consistent and accurate as previously described).

If partially untrained prototype inference model 206 provides the inconsistent responses to the first set of prompts and the consistent and accurate responses to the second set of prompts, performance criteria 210 may be met and updated prototype inference model 212 may be obtained. Updated prototype inference model 212 may be partially untrained prototype inference model 206 and/or may be a further untrained prototype inference model (not shown) following additional partial untraining and/or testing processes if partially untrained prototype inference model 206 does not meet performance criteria 210.

Therefore, performance criteria 210 may define at least: (i) a first level of ability of updated prototype inference model 212 to utilize information content of the portion of training data 200 to generate desirable responses to the first set of prompts (e.g., the first level of ability being based on the inconsistent responses) and (ii) a second level of ability of updated prototype inference model 212 to utilize the other information content of the other training data of training data 200 to generate desirable responses to the second set of prompts (e.g., the second level of ability being based on the consistent and accurate responses). Refer to FIG. 2C for additional details regarding the first level of ability and refer to FIG. 2G for additional details regarding the second level of ability.

If performance criteria 210 are not met during testing process 208, partial untraining process 204 may be repeated (e.g., as shown in FIG. 2A with the arrow returning from testing process 208 to partial untraining process 204). Therefore, a second partial untraining process may be performed. The second partial untraining process may be similar to the first partial untraining process (e.g., 204) with the goal of further reducing partially untrained prototype inference model 206's ability to generate responses based on the information content of the portion of training data 200. Doing so may result in obtaining a further untrained prototype inference model (not shown). Following obtaining the further untrained prototype inference model, a second testing process may be performed, the second testing process being similar to testing process 208. Cycles of untraining (e.g., partial untraining processes) and testing may continue until performance criteria 210 are met.

To obtain production ready inference model 216, updated prototype inference model 212 may be used to perform promotion process 214. During promotion process 214, updated prototype inference model 212 may be deemed production ready. Doing so may include: (i) modifying a title of updated prototype inference model 212, (ii) notifying another entity that production ready inference model 216 has been obtained, and/or (iii) other methods.

Production ready inference model 216 may be used to provide computer-implemented services including, for example, inference (e.g., response) generation.

Thus, by implementing the data flows shown in FIG. 2A, a system in accordance with embodiments disclosed herein may be used to obtain a production ready inference model based on a prototype inference model. By testing a partially updated prototype inference model using the prototype inference model (and/or another trusted model), untraining may stop once performance criteria are met, which may conserve resources during the untraining procedure.

Turning to FIG. 2B, a second data flow diagram in accordance with an embodiment is shown. The second data flow diagram may illustrate data used in and data processing performed in performing a first testing procedure to determine whether a partially untrained prototype inference model provides inconsistent responses to a first set of prompts. The processes shown in FIG. 2B may be a partial expansion of testing process 208 shown in FIG. 2A.

To perform the first testing procedure, inferencing process 222 may be performed using prompts 220 (e.g., the first set of prompts). Prompts 220 may be obtained, for example, via: (i) generation by a SME, (ii) generation by a third inference model (not shown), and/or (iii) other methods. The third inference model (not shown) may also be a generative AI model (e.g., a third LLM).

Prompts 220 may be a set of prompts including any number of prompts (e.g., 220A-220N) that may be adapted to elicit responses from inference models including the information content (e.g., from the portion of training data 200 desired to be removed from the knowledge base). Prompt 220A, for example, may include human-interpretable text and may include a question to be answered by partially untrained prototype inference model 206. Prompt 220A may: (i) include a solicitation for the same information content (e.g., as other prompts of prompts 220), and (ii) use a different phrasing from phrasings used by the other prompts of prompts 220.

For example, partially untrained prototype inference model 206 may be trained using a set of training data including news articles published by a news entity. However, access to the news articles for purposes of training generative AI models (e.g., the prototype inference model) may be revoked (e.g., due to data use policies of the news entity). Consequently, the prototype inference model (e.g., prototype inference model 202) may be untrained in an attempt to reduce an ability of prototype inference model 202 to provide responses to prompts based on information content of the news articles.

Partially untrained prototype inference model 206 may be intended to have a reduced knowledge base (e.g., without the information content of the news articles) compared to a knowledge base of prototype inference model 202 (e.g., having the information content of the news articles). Prompt 220A may include a solicitation (e.g., question) for partially untrained prototype inference model 206 to provide a summary of a news article generated by the news entity using a first phrasing. Prompt 220B may include a second solicitation for partially untrained prototype inference model 206 to provide the summary of the news article generated by the news entity (e.g., the same information content) using a second phrasing.

The first phrasing may include human-interpretable text such as “what did news entity A say about topic B” and the second phrasing may include human-interpretable text such as “explain topic B.” For example, in the first phrasing and the second phrasing, topic B may include opinions and/or other content exclusive to news entity A. Therefore, if partially untrained prototype inference model 206 provides a summary of topic B, it may be concluded that partially untrained prototype inference model 206 is trained using the content exclusive to news entity A. Other prompts of prompts 220 may include other phrasings. However, each prompt of prompts 220 may be intended to elicit the same information content that includes the portions of information content from news articles generated by the news entity.

During inferencing process 222, prompts 220 may be fed into partially untrained prototype inference model 206 and responses 224 may be obtained from partially untrained prototype inference model 206. Responses 224 may include any number of responses (e.g., 224A-224N).

Each response of responses 224 may be responsive to a prompt of prompts 220. For example, response 224A may be responsive to prompt 220A. If partially untrained prototype inference model 206 is hosted by a remote resource, responses 224 may be obtained from the remote resource (e.g., by a local resource, by a first owner) in response to prompts 220.

Responses 224 may include at least a first response (e.g., response 224A) with a first information content and a second response (e.g., response 224B) with a second information content. Continuing with the above example where prompts 220 may include requests for a summary of a news article generated by the news entity, the first information content and the second information content may be intended to include a summary of the news article. Partially untrained prototype inference model 206 may be provided (e.g., as part of prompts 220, prior to inferencing process 222) with additional contextual information, specific graphical user interfaces (GUIs), and/or other information to narrow a scope of responses 224 to an application relevant to a downstream consumer of responses 224).

To evaluate agreement between responses of responses 224, response agreement testing process 226 may be performed. During response agreement testing process 226, responses 224 and a second LLM trained to compare information content of data structures provided as ingest (e.g., responses 224), such as prototype inference model 202, may be used to obtain level of agreement 228. To do so, a response agreement testing prompt (not shown) may be provided to prototype inference model 202.

The response agreement testing prompt may include: (i) responses 224, (ii) instructions for comparing information content of responses 224, and/or (iii) other information such as contextual information usable to compare responses 224. For example, the response agreement testing prompt may instruct prototype inference model 202 to: (i) determine whether at least response 224A and response 224B seem to be responsive to a same prompt (e.g., question), (ii) determine whether response 224A and response 224B seem to have a same information content, and/or (iii) otherwise compare responses 224.

During response agreement testing process 226, an output may be obtained from prototype inference model 202 in response to providing the agreement testing prompt to prototype inference model 202. The output may include level of agreement 228 and/or may include information usable to obtain level of agreement 228. For example, the information usable to obtain level of agreement 228 may include: (i) a list of responses of responses 224 that prototype inference model 202 considers as having a same information content, (ii) a list of prompts of prompts 220 that prototype inference model 202 considers equivalent (e.g., via determining that responses to the prompts have a same information content), and/or (iii) other information. Therefore, during response agreement testing process 226, level of agreement 228 may be obtained (e.g., by reading the levels of agreement from the output, by analyzing and/or processing the output to obtain the levels of agreement).

Level of agreement 228 may indicate degrees of similarity between responses of responses 224 (e.g., between at least response 224A and response 224B). For example, level of agreement 228 may include: (i) a number of responses 224 that prototype inference model 202 considers equivalent (e.g., shown as a number and/or as a percentage), (ii) a number of responses 224 that prototype inference model 202 considers to be answers to a same prompt (e.g., shown as a number and/or as a percentage), and/or (iii) other quantifications of the degree of similarity.

Turning to FIG. 2C, a third data flow diagram in accordance with an embodiment is shown. The third data flow diagram may illustrate data used in and data processing performed in performing a portion of a first testing procedure to determine whether a partially untrained prototype inference model provides inconsistent responses to a first set of prompts. The processes shown in FIG. 2C may be a partial expansion of testing process 208 shown in FIG. 2A.

To determine whether partially untrained prototype inference model 206 provides the inconsistent responses to prompts 220, comparison process 230 may be performed. During comparison process 230, it may be determined whether level of agreement 228 (e.g., described in FIG. 2B) meets agreement criteria 232. Agreement criteria 232 may be provided by a downstream consumer, a SME, and/or any other entity participating in management of inference models. Agreement criteria 232 may include any number of thresholds, rule sets, and/or other means of determining whether degrees of similarity between responses 224 indicate that responses 224 are deemed consistent and/or inconsistent.

For example, agreement criteria 232 may include: (i) a threshold number and/or percentage of responses (e.g., 224) that prototype inference model 202 (and/or another inference model) considers equivalent that, when met, may indicate that responses 224 are to be deemed consistent, (ii) a threshold number of responses 224 that prototype inference model 202 (and/or another inference model) considers to be answers to a same prompt that, when met, may indicate that responses 224 are to be deemed consistent, and/or (iii) other thresholds. Agreement criteria 232 may be based on at least a portion of performance criteria 210 described in FIG. 2A.

If a quantity included in level of agreement 228 falls below a corresponding threshold of agreement criteria 232, it may be concluded that partially untrained prototype inference model 206 provides inconsistent responses to the first set of prompts and, therefore, has been sufficiently untrained with respect to the portion of the training data. If the quantity included in level of agreement 228 exceeds the first corresponding threshold of agreement criteria 232 (and/or meets the threshold), it may be concluded that partially untrained prototype inference model 206 provides consistent responses to the first set of prompts and, therefore, has not been sufficiently untrained with respect to the portion of the training data.

For example, level of agreement 228 may indicate that 23% of responses 224 are considered to have a same information content and agreement criteria 232 may include a threshold quantity of less than 75% of responses having the same information content to be considered inconsistent. Level of agreement 228 may meet agreement criteria 232 if level of agreement 228 falls below the threshold quantity (e.g., thereby indicating that partially untrained prototype inference model 206 is sufficiently untrained with respect to the portion of the training data). Therefore, in this example, level of agreement 228 may meet agreement criteria 232. Consequently, partially untrained prototype inference model 206 may be considered sufficiently untrained with respect to the portion of the training data.

While described above with respect to a single quantity and a single corresponding threshold, it may be appreciated that any number of quantities may be compared to any number of corresponding thresholds and/or any other types of rules may be applied to determine whether agreement criteria 232 are met.

As a result of comparison process 230, result 234 may be obtained. Result 234 may include an indication of whether partially untrained prototype inference model 206 provides the inconsistent responses. For example, result 234 may include a “yes” or “no” answer, may include any quantities of level of agreement 228, and/or may include other information.

If result 234 indicates that partially untrained prototype inference model 206 does not provide the inconsistent responses (e.g., responses 224 were deemed consistent), a second partial untraining procedure for partially untrained prototype inference model 206 may be performed to improve a likelihood that a further untrained prototype inference model based on partially untrained prototype inference model 206 provides the inconsistent responses. Refer to the description of FIG. 2A for additional details regarding performing the second partial untraining procedure.

If result 234 indicates partially untrained prototype inference model 206 does provide the inconsistent responses, it may indicate that the information content of the portion of training data 200 has been sufficiently removed from the knowledge base of partially untrained prototype inference model 206 (e.g., a second knowledge base of the partially untrained prototype inference model may not have the information content of the portion of the training data). A second testing procedure may then be performed to determine whether partially untrained prototype inference model 206 provides consistent and accurate responses to a second set of prompts based on other information content desired to be retained in the knowledge base of partially untrained prototype inference model 206. Refer to the description of FIGS. 2D-2G for additional details regarding the second testing procedure.

In addition, while described in FIGS. 2B-2C as obtaining level of agreement 228 from prototype inference model 202 and performing comparison process 230 using level of agreement 228 and agreement criteria 232, it may be appreciated that prototype inference model 202 may also perform at least a portion of comparison process 230 and an output from prototype inference model 202 during response agreement testing process 226 may include a determination of whether partially untrained prototype inference model 206 provides the inconsistent responses.

Following obtaining result 234 (and/or at other times such as prior to performing comparison process 230), additional testing processes may be performed to further interrogate responses of responses 224 that were determined to be equivalent during response agreement testing process 226. For example, a first response (e.g., response 224A) and a second response (e.g., response 224B) may be determined to be equivalent by prototype inference model 202. In response, prototype inference model 202 may be prompted to explain a difference between response 224A and response 224B. Prototype inference model 202 may generate a second output and the second output may include a description of the difference between response 224A and response 224B as determined by prototype inference model 202. The second output may be evaluated (e.g., by an SME, by another entity, by a different inference model) to determine whether to retain or change a status of response 224A and response 224B being equivalent.

Turning to FIG. 2D, a fourth data flow diagram in accordance with an embodiment is shown. The fourth data flow diagram may illustrate data used in and data processing performed in performing a portion of a second testing procedure to determine whether a partially untrained prototype inference model provides consistent and accurate responses to a second set of prompts. The processes shown in FIG. 2D may be a partial expansion of testing process 208 shown in FIG. 2A.

To perform the second testing procedure, inferencing process 242 may be performed using prompts 240 (e.g., the second set of prompts). Prompts 240 may be obtained, for example, via: (i) generation by a SME, (ii) generation by a third inference model (not shown), and/or (iii) other methods. The third inference model (not shown) may also be a generative AI model (e.g., a third LLM).

Prompts 240 may be a set of prompts including any number of prompts (e.g., 240A-240N) that may be adapted to elicit responses from inference models including other information content (e.g., from the other training data of training data 200 desired to be retained with the knowledge base of partially untrained prototype inference model 206). Prompt 240A, for example, may include human-interpretable text and may include a question to be answered by partially untrained prototype inference model 206. Prompt 240A may: (i) include a solicitation for a same information content (e.g., as other prompts of prompts 240), and (ii) use a different phrasing from phrasings used by the other prompts of prompts 240.

Returning to the previous example in which partially untrained prototype inference model 206 was untrained for a portion of the training data that includes news articles generated by a news entity, partially untrained prototype inference model 206 may be intended to retain other information content from other training data. The other information content may include news articles from other entities.

To test whether a knowledge base of partially untrained prototype inference model 206 has the other information content, prompt 240A may include a solicitation (e.g., question) for partially untrained prototype inference model 206 to provide a summary of a news article from one of the other entities using a first phrasing. Prompt 240B may include a second solicitation for partially untrained prototype inference model 206 to provide the summary of the news article (e.g., the same information content) using a second phrasing.

The first phrasing may include human-interpretable text such as “what did entity C say about topic D” and the second phrasing may include human-interpretable text such as “summarize topic D.” For example, in the first phrasing and the second phrasing, entity C may be one of the other entities and topic D may include opinions and/or other content exclusive to entity C. Therefore, if partially untrained prototype inference model 206 provides a summary of topic D, it may be concluded that partially untrained prototype inference model 206 is trained using the content exclusive to entity C. Other prompts of prompts 240 may include other phrasings. However, each prompt of prompts 240 may be intended to elicit the same information content that includes the summary of the news article from the one of the other entities.

During inferencing process 242, prompts 240 may be provided to partially untrained prototype inference model 206. Inferencing process 242 may be similar to inferencing process 222 described in FIG. 2B. During inferencing process 242, prompts 240 may be fed into partially untrained prototype inference model 206 and responses 244 may be obtained from partially untrained prototype inference model 206. Responses 244 may include any number of responses (e.g., 244A-244N). Each response of responses 244 may be responsive to a prompt of prompts 240. For example, response 244A may be responsive to prompt 240A. If partially untrained prototype inference model 206 is hosted by the remote resource, responses 244 may be obtained from the remote resource (e.g., by the local resource, by the first owner) in response to prompts 240.

Responses 244 may include at least a first response (e.g., response 244A) with a first information content and a second response (e.g., response 244B) with a second information content. Continuing with the above example where prompts 240 may include requests for summaries of news articles, the first information content and the second information content may be intended to include the summaries. Partially untrained prototype inference model 206 may be provided (e.g., as part of prompts 240, prior to inferencing process 242) with additional contextual information, specific graphical user interfaces (GUIs), and/or other information to narrow a scope of responses 244 to an application relevant to a downstream consumer of responses 244.

To evaluate agreement between responses of responses 244, response agreement testing process 246 may be performed. Response agreement testing process 246 may be similar to response agreement testing process 226 described in FIG. 2B. During response agreement testing process 246, responses 244 and a second LLM trained to compare information content of data structures provided as ingest (e.g., responses 244), such as prototype inference model 202, may be used to obtain level of agreement 248. To do so, a response agreement testing prompt (not shown) may be provided to prototype inference model 202.

The response agreement testing prompt may include: (i) responses 244, (ii) instructions for comparing information content of responses 244, and/or (iii) other information such as contextual information usable to compare responses 244. For example, the response agreement testing prompt may instruct prototype inference model 202 to: (i) determine whether at least response 244A and response 244B seem to be responsive to a same prompt (e.g., question), (ii) determine whether at least response 244A and response 244B seem to have a same information content, and/or (iii) otherwise compare responses 244.

During response agreement testing process 246, an output may be obtained from prototype inference model 202 in response to providing the agreement testing prompt to prototype inference model 202. The output may include level of agreement 248 and/or may include information usable to obtain level of agreement 248. For example, the information usable to obtain level of agreement 248 may include: (i) a list of responses of responses 244 that prototype inference model 202 considers as having a same information content, (ii) a list of prompts of prompts 240 that prototype inference model 202 considers equivalent (e.g., via determining that responses to the prompts have a same information content), and/or (iii) other information. Therefore, during response agreement testing process 246, level of agreement 248 may be obtained (e.g., by reading the levels of agreement from the output, by analyzing and/or processing the output to obtain the levels of agreement).

Level of agreement 248 may indicate degrees of similarity between responses of responses 244 (e.g., between at least response 244A and response 244B). For example, level of agreement 248 may include: (i) a number of responses 244 that prototype inference model 202 considers equivalent (e.g., shown as a number and/or as a percentage), (ii) a number of responses 244 that prototype inference model 202 considers to be answers to a same prompt (e.g., shown as a number and/or as a percentage), and/or (iii) other quantifications of the degree of similarity.

Turning to FIG. 2E, a fifth data flow diagram in accordance with an embodiment is shown. The fifth data flow diagram may illustrate data used in and data processing performed in performing a portion of a second testing procedure to determine whether a partially untrained prototype inference model provides consistent and accurate responses to a second set of prompts. The processes shown in FIG. 2E may be a partial expansion of testing process 208 shown in FIG. 2A.

To determine whether partially untrained prototype inference model 206 provides the consistent responses to prompts 240, comparison process 250 may be performed. During comparison process 250, it may be determined whether level of agreement 248 (e.g., described in FIG. 2D) meets agreement criteria 232. If level of agreement 248 meets agreement criteria 232, partially untrained prototype inference model 206 may provide consistent responses to the second set of prompts. Refer to the description of FIG. 2C for additional details regarding agreement criteria 232.

If a quantity included in level of agreement 248 meets a corresponding threshold of agreement criteria 232, it may be concluded that partially untrained prototype inference model 206 provides consistent responses to the second set of prompts. If the quantity included in level of agreement 248 does not meet the corresponding threshold of agreement criteria 232, it may be concluded that partially untrained prototype inference model 206 does not provide the consistent responses to the second set of prompts.

For example, level of agreement 248 may indicate that 83% of responses 244 are considered to have a same information content and agreement criteria 232 may include a threshold quantity of at least 75% of responses having the same information content to be deemed consistent. Level of agreement 248 may meet agreement criteria 232 if level of agreement 248 meets the threshold quantity (e.g., thereby indicating that partially untrained prototype inference model 206 is sufficiently trained with respect to the other training data). Therefore, in this example, level of agreement 248 may meet agreement criteria 232.

While described above with respect to a single quantity and a single corresponding threshold, it may be appreciated that any number of quantities may be compared to any number of corresponding thresholds and/or any other types of rules may be applied to determine whether agreement criteria 232 are met.

As a result of comparison process 250, result 252 may be obtained. Result 252 may include an indication of whether partially untrained prototype inference model 206 provides the inconsistent responses. For example, result 252 may include a “yes” or “no” answer, may include any quantities of level of agreement 248, and/or may include other information.

If result 252 indicates that partially untrained prototype inference model 206 does not provide the consistent responses (e.g., responses 244 were deemed inconsistent), partially untrained prototype inference model may not be used as production ready inference model 216.

If result 252 indicates partially untrained prototype inference model 206 does provide the consistent responses, it may indicate that the information content of the other training data of training data 200 has been retained with the knowledge base of partially untrained prototype inference model 206. The second testing procedure may then be continued to determine whether partially untrained prototype inference model 206 provides accurate responses to the second set of prompts.

In addition, while described in FIGS. 2D-2E as obtaining level of agreement 248 from prototype inference model 202 and performing comparison process 250 using level of agreement 248 and agreement criteria 232, it may be appreciated that prototype inference model 202 may also perform at least a portion of comparison process 250 and an output from prototype inference model 202 during response agreement testing process 246 may include a determination of whether partially untrained prototype inference model 206 provides the consistent responses.

Following obtaining result 252 (and/or at other times such as prior to performing comparison process 250), additional testing processes may be performed to further interrogate responses of responses 244 that were determined to not be equivalent during response agreement testing process 246. For example, a first response (e.g., response 244A) and a second response (e.g., response 244B) may be determined to not be equivalent by prototype inference model 202. In response, prototype inference model 202 may be prompted to explain a difference between response 244A and response 244B. Prototype inference model 202 may generate a second output and the second output may include a description of the difference between response 244A and response 244B as determined by prototype inference model 202. The second output may be evaluated (e.g., by an SME, by another entity, by a different inference model) to determine whether to retain or change a status of response 244A and response 244B being non-equivalent.

Turning to FIG. 2F, a sixth data flow diagram in accordance with an embodiment is shown. The sixth data flow diagram may illustrate data used in and data processing performed in performing, at least in part, the second testing procedure for partially untrained prototype inference model 206. The second testing procedure may include attempting to verify whether partially untrained prototype inference model 206 provides accurate responses to the second set of prompts (e.g., prompts 240). To do so, an information content of a set of responses (e.g., responses 244) from partially untrained prototype inference model 206 may be compared to other information content of other training data of training data 200 that is desired to be retained with the knowledge base of partially untrained prototype inference model 206 (e.g., other training data 254).

While it may be determined that partially untrained prototype inference model 206 provides consistent responses to the second set of prompts (e.g., prompts 240) (refer to FIGS. 2D-2E), it may not be concluded whether the knowledge base of partially untrained prototype inference model 206 has the other information content from other training data 254. For example, partially untrained prototype inference model 206 may provide consistent responses to prompts 240 which are inaccurate, incorrect, and/or otherwise erroneous.

Returning to the example where partially untrained prototype inference model 206 is trained using training data that includes news articles from different entities, partially untrained prototype inference model 206 may provide consistent responses to a set of prompts including a solicitation for a summary of a news article. For example, the responses may include summaries with a same first information content. While the responses may include a same first information content, the responses may be inaccurate. For example, the other training data may include articles and/or summaries of articles with a second information content. Thus, partially untrained prototype inference model 206 may provide responses to the second set of prompts which are consistent, yet inaccurate. If the responses are inaccurate, it may be concluded that the knowledge base of partially untrained prototype inference model 206 does not have the other information content.

To determine whether the knowledge base of partially untrained prototype inference model 206 has the other training data, comparison process 256 may be performed. During comparison process 256, a first information content of responses 244 may be compared to a second information content of other training data 254. Responses 244 may include a set of responses (e.g., 244A-244N) obtained during inferencing process 242 described in FIG. 2D and may be responsive to a set of prompts (e.g., prompts 240, not shown). The second set of prompts may be intended to elicit responses including the second information content of other training data 254. Thus, responses 244 may be considered accurate if the first information content of responses 244 is consistent with (e.g., considered sufficiently the same as) at least a portion of the second information content of other training data 254 based on any criteria.

Comparing the first information content of responses 244 to the second information content of other training data 254 may include: (i) prompting prototype inference model 202 (and/or another trusted LLM) to compare the first information content and the second information content to obtain level of similarity 258, (ii) providing the first information content and the second information content to a SME and or other entity for comparison, and/or (iii) other methods.

Prototype inference model 202 may be prompted to compare the first information content and the second information content by feeding at least responses 244 and at least a portion of other training data 254 into prototype inference model 202. For example, a level of similarity prompt may be provided to prototype inference model 202 (not shown) and the level of similarity prompt may instruct prototype inference model 202 to determine whether responses 244 and other training data 254 seem to have a same information content and/or otherwise compare responses 244 to other training data 254.

During comparison process 256, an output may be obtained from prototype inference model 202 in response to providing the level of similarity prompt prototype inference model 202. The output may include level of similarity 258 indicating an extent of similarity between the first information content and the second information content (not shown) and/or may include information usable to obtain level of similarity 258.

For example, the information usable to obtain level of similarity 258 may include a list of responses of responses 244 that prototype inference model 202 considers as having a same information content as other training data 254 and/or other information. Level of similarity 258 may indicate an extent to which the first information content matches the second information content.

For example, level of similarity 258 may include: (i) a number of responses 244 that prototype inference model 202 considers consistent (e.g., considers as having a same information content) with other training data 254 (e.g., shown as a number and/or as a percentage), and/or (ii) other quantifications of the level of similarity.

Turning to FIG. 2G, a seventh data flow diagram in accordance with an embodiment is shown. The seventh data flow diagram may illustrate data used in and data processing performed in performing, at least in part, the second testing procedure for partially untrained prototype inference model 206. The processes shown in FIG. 2G may be a partial expansion of testing process 208 shown in FIG. 2A.

To determine whether level of similarity 258 indicates that responses 244 are accurate with respect to the second set of prompts, comparison process 260 may be performed. During comparison process 260, level of similarity 258 may be compared level of similarity threshold 262. Level of similarity threshold 262 may be based on any criteria for accuracy of an inference model and may be obtained from: (i) a SME, (ii) a downstream consumer, (iii) another inference model, (iv) the first owner (e.g., of the local resource), and/or (v) from any other entity and/or source.

For example, level of similarity threshold 262 may be based on at least a portion of performance criteria 210 described in FIG. 2A. Level of similarity threshold 262 may be based on the second level of ability of partially untrained prototype inference model 206 to utilize the other information content from the other training data (e.g., other training data 254 described in FIG. 2F) that was not intended to be untrained for (e.g., partial untraining process 204) to generate desirable (e.g., consistent and accurate) responses to the second set of prompts (e.g., prompts 240 described in FIG. 2D). Consequently, partially untrained prototype inference model 206 may have the second level of ability when partially untrained prototype inference model 206 has a sufficiently high ability to utilize the other information content to generate the desirable responses to the second set of prompts (e.g., based on level of similarity threshold 262).

If partially untrained prototype inference model 206 meets the criteria for accuracy (e.g., level of similarity 258 meets level of similarity threshold 262), it may be concluded that partially untrained prototype inference model 206 provides accurate responses to the second set of prompts and thus, has a knowledge base that retains the other information content of the other training data.

For example, level of similarity 258 may include a percentage indicating an extent to which the first information content (e.g., of responses 244 described in FIGS. 2D-2F) is considered consistent with the second information content (e.g., of other training data 254 described in FIG. 2F). Level of similarity 258 may, therefore, indicate that the first information content is 88% similar to the second information content. Level of similarity threshold 262 may indicate that the first information content must be considered to be at least 85% similar to the second information content for partially untrained prototype inference model 206 to be considered consistent with other training data 254 and, therefore, provide accurate responses. Consequently, in this example, partially untrained prototype inference model 206 may provide the accurate responses.

As a result of comparison process 260, result 264 may be obtained. Result 264 may include a “yes” or “no” designation regarding whether partially untrained prototype inference model 206 provides the accurate responses to the second set of prompts based on the comparison between level of similarity 258 and level of similarity threshold 262.

If result 264 indicates that partially untrained prototype inference model 206 provides the accurate responses, it may be concluded that partially untrained prototype inference model 206 has a knowledge base that retains the other information content of the other training data following the first partial untraining procedure. Partially untrained prototype inference model 206 may then be used as an updated prototype inference model (e.g., updated prototype inference model 212 described in FIG. 2A) and no additional untraining procedures may be performed.

Updated prototype inference model 212 may then be promoted to a production ready inference model (e.g., production ready inference model 216 described in FIG. 2A) and used to provide computer-implemented services. Doing so may include replacing prototype inference model 202 with production ready inference model 216 for at least a portion of providing the computer-implemented services. Replacing prototype inference model 202 with production ready inference model 216 may include sending prompts to production ready inference model 216 rather than sending prompts to prototype inference model 202 and using responses generated by production ready inference model 216 as part of providing the computer-implemented services.

If result 264 indicates that partially untrained prototype inference model 206 does not provide the accurate responses, partially untrained prototype inference model 206 may not be used as updated prototype inference model 212 (described in FIG. 2A).

Thus, by implementing the data flow shown in FIG. 2F-2G, a system in accordance with embodiments disclosed herein may be used to test whether a partially untrained prototype inference model provides accurate responses to a second set of prompts based on other training data with an information content desired to be retained in the knowledge base of the partially untrained prototype inference model. By utilizing another inference model during the process of evaluating response accuracy (e.g., the prototype inference model), resources may be conserved while determining whether the partially untrained prototype inference model provides the accurate responses. Consequently, resources may be allocated to providing the computer-implemented services and a likelihood that the computer-implemented services may be provided as desired to downstream consumers may be increased.

Any of the processes illustrated using the second set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor based devices (e.g., computer chips).

Any of the data structures illustrated using the first set of shapes may be implemented using any type and number of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

To further clarify embodiments disclosed herein, an inference model diagram in accordance with an embodiment is shown in FIG. 2H. The inference model diagram may illustrate a structure of the inference models and/or how data is processed/used within the system of FIG. 1 while performing an untraining procedure for an inference model (e.g., prototype inference model 202).

Turning to FIG. 2H, a diagram illustrating a neural network (e.g., an implementation of an inference model) in accordance with an embodiment is shown. In FIG. 2H, neural network 270 may be similar to any inference model managed by local resource 102 and/or remote resource 106, discussed in FIG. 2A. For example, neural network 270 may be similar to prototype inference model 202 described in FIGS. 2A-2G. Neural network 270 may include a series of layers of nodes (e.g., neurons, illustrated as circles). This series of layers may include input layer 272, hidden layer 274 (which may include different sub-layers of neurons), and output layer 276. Lines terminating in arrows in this diagram indicate data relationships (e.g., weights). For example, numerical values calculated with respect to each of the neurons during operation of neural network 270 may depend on the values calculated with respect to other neurons linked by the lines (e.g., the weight associated with each line may impact the level of dependence of the value for a second neuron for the value for neuron from which the line initiates). The value calculated with respect to a first neuron may be based, at least in part, on the values of other neurons from which the arrows that terminate in the neuron initiate from.

Each of the layers of neurons of neural network 270 may include any number of neurons and may include any number of sub-layers.

To decrease a likelihood that inferences generated by the inference model are based on portions of the sensitive and/or poisoned information (thereby indicating that the inference model has been sufficiently untrained on the portions of the sensitive and/or poisoned information), embodiments disclosed herein may provide a system and method for untraining inference models with respect to portions of training data previously used to train the inference models. To do so, the system may modify the architecture of neural network 270.

During a partial untraining procedure (e.g., partial untraining process 204 described in FIG. 2A), weights of neural network 270 may be modified to reduce an ability of neural network 270 to generate consistent and accurate responses to prompts intended to elicit an information content of the sensitive and/or poisoned training data. To do so, weights of input layer 272, hidden layer 274, and/or output layer 276 may be placed in a mutable state and a process such as gradient ascent with respect to an inference error may be performed. Completion of this partial untraining procedure may provide an updated set of weights for neural network 270. By doing so, the partial untraining procedure may cause neural network 270 to no longer provide responses that are based on the information content of the sensitive and/or poisoned training data. The partial untraining procedure may include other methods without departing from embodiments disclosed herein.

While illustrated in FIG. 2H as including a limited number of specific components, a neural network may include fewer, additional, and/or different components than those illustrated in these figures without departing from embodiments disclosed herein.

As discussed above, the components of FIGS. 1-2H may perform various methods to manage inference models. FIGS. 3A-3D illustrate a method that may be performed by the components of the system of FIGS. 1-2H. In the diagrams discussed below and shown in FIGS. 3A-3D, any of the operations may be repeated, performed in different orders, and/or performed in parallel with or in a partially overlapping in time manner with other operations.

Turning to FIG. 3A, a first flow diagram illustrating a method for providing computer-implemented services using inference models in accordance with an embodiment is shown. The method may be performed, for example, by any of the components of the system of FIG. 1, and/or any other entity without departing from embodiments disclosed herein.

At operation 300, it may be identified that a portion of training data used to train a prototype inference model has an information content that is to be removed from a knowledge base of the prototype inference model. Identifying that a portion of the training data is to be removed from the knowledge base may include obtaining a notification indicating that the portion of the training data is to be removed from the knowledge base (e.g., reading the notification from storage, receiving the notification from another entity, generating the notification). The notification may indicate sensitive information that is to be removed from the knowledge base. Identifying that the portion of the training data is to be removed from the knowledge base may also include: (i) obtaining a list of sensitive (e.g., proprietary, confidential, private) information, (ii) parsing the training data to identify any of the sensitive information included in the training data, (iii) labeling any inference models trained using training data that includes the sensitive information for untraining, and/or (iv) other methods.

At operation 302, performance of an untraining procedure for the prototype inference model may be initiated using at least the portion of the training data, a first set of prompts based on the portion of the training data, and a second set of prompts based on other training data of the training data until performance criteria are met to obtain an updated prototype inference model. The performance criteria may be usable to identify when the untraining procedure is complete and the performance criteria may define at least: (i) a first level of ability of the updated prototype inference model to utilize the information content to generate desirable responses to the first set of prompts and (ii) a second level of ability of the updated prototype inference model to utilize the other information content to generate desirable responses to the second set of prompts.

Initiating performance of the untraining procedure may include: (i) performing, using the training data, a first partial untraining procedure for the prototype inference model to obtain a partially untrained prototype inference model, and/or (ii) performing, using the prototype inference model, a first testing procedure to determine whether the partially untrained prototype inference model provides inconsistent responses to the first set of prompts. If the partially untrained prototype inference model provides the inconsistent responses, initiating performance of the untraining procedure may also include performing a second testing procedure to determine whether the partially untrained prototype inference model provides consistent and accurate responses to the second set of prompts. If the partially untrained prototype inference model provides the consistent and accurate responses to the second set of prompts, initiating performance of the untraining procedure may also include concluding that the partially untrained prototype inference model meets the performance criteria to obtain the updated prototype inference model. Refer to FIG. 3B for additional details regarding initiating performance of the untraining procedure.

At operation 304, it may be determined whether the performance criteria are met. Determining whether the performance criteria are met may include reading a result of the untraining procedure and/or testing procedures described in operation 302. In addition, determining whether the performance criteria are met may include receiving a notification from another entity responsible for determining whether the performance criteria are met, the notification including a “yes” or “no” designation and/or any other indication of whether the performance criteria are met.

If the performance criteria are met, the method may proceed to operation 306.

At operation 306, the updated prototype inference model may be promoted to a production ready inference model. Promoting the updated prototype inference model to a production ready inference model may include: (i) concluding the updated prototype inference model is sufficiently untrained (e.g., identifying that the untraining procedure is complete, not continuing to perform additional partial untraining procedures for the updated prototype inference model), (ii) generating a data structure indicating that the updated prototype inference model has been promoted to the production ready inference model, (iii) storing the data structure in a database and/or other storage architecture for retrieval during providing the computer-implemented services, (iv) notifying (e.g., via a message over a communication system, via a graphical user interface (GUI) on a device) another entity (e.g., the remote resource, the local resource, a downstream consumer) that the updated prototype inference model has been promoted to the production ready inference model and, therefore, approved for use in providing the computer-implemented services, and/or (v) other methods.

At operation 308, the production ready inference model may be used to provide the computer-implemented services. Using the production ready inference model may include replacing the prototype inference model with the production ready inference model in the provision of the computer-implemented services. Replacing the prototype inference model may include: (i) modifying instructions for inference generation, the instructions including a list of inference models usable for generation of inferences during providing the computer-implemented services (e.g., removing the prototype inference model from the list, adding the production ready inference model to the list, labeling the prototype inference model in the list as being replaced by the production ready inference model), (ii) providing the instructions and/or another notification to any entity (e.g., the remote resource, a downstream consumer) indicating that the prototype inference model is to be replaced by the production ready inference model, and/or (iii) other methods.

Providing the computer-implemented services using the production ready inference model may also include: (i) notifying (e.g., via a message over a communication system, via a graphical user interface (GUI) on a device) another entity (e.g., the remote resource, the local resource, a downstream consumer) that the production ready inference model is approved for use in providing the computer-implemented services, (ii) obtaining a new prompt for the production ready inference model, (iii) providing the new prompt to the production ready inference model (e.g., feeding the new prompt to the production ready inference model as ingest), (iv) receiving, in response to the new prompt, a new response generated by the production ready inference model, (v) providing at least a portion of the new response to a downstream consumer as part of providing the computer-implemented services, (v) using at least a portion of the new response to make decisions related to provisioning of the computer-implemented services, and/or (vi) other methods.

The method may end following operation 306.

Returning to operation 304, the method may proceed to operation 310 if the performance criteria are not met.

At operation 310, performance of a second untraining procedure for the updated prototype inference model may be initiated to increase a likelihood that the performance criteria are met. Initiating performance of the second untraining procedure may include: (i) performing a second partial untraining procedure for the partially untrained prototype inference model using at least a portion of the training data (and/or other additional training data) to obtain a further partially untrained prototype inference model, and/or (ii) performing a third testing procedure to determine whether the further partially untrained prototype inference model provides inconsistent responses to the first set of prompts. If the further untrained prototype inference model provides the inconsistent responses, a fourth testing procedure may be performed to determine whether the further untrained prototype inference model provides consistent and accurate responses to the second set of prompts. If the further untrained prototype inference model provides the consistent and accurate responses, it may be concluded that the further partially untrained prototype inference model meets the performance criteria and the further untrained prototype inference model may be used as the updated prototype inference model.

Performing the second partial untraining procedure, the third testing procedure, and the fourth testing procedure may include methods similar to those described with respect to operation 302. Additional partial untraining procedures and testing procedures may be performed until the performance criteria are met.

The method may end following operation 310.

Thus, as illustrated above, embodiments disclosed herein may provide systems and methods usable to manage inference models so that an inference model may be untrained on sensitive information (e.g., proprietary information, confidential information, private information) thereby reducing the inference model's ability to generate responses based on the sensitive information. By testing the inference model's ability to generate the responses periodically throughout the untraining procedure using a second inference model, the untraining procedure may be stopped when performance criteria are met for the inference model thereby conserving resources that may otherwise be allocated to additional untraining cycles. Consequently, the resources may be available for use in providing computer-implemented services.

Turning to FIG. 3B, a second flow diagram illustrating a method for initiating performance of an untraining procedure for a prototype inference model in accordance with an embodiment is shown. The method may be performed, for example, by any of the components of the system of FIG. 1, and/or any other entity without departing from embodiments disclosed herein. The operations shown in FIG. 3B may be an expansion of operation 302 in FIG. 3A.

At operation 320, a first partial untraining procedure may be performed for the prototype inference model using training data to obtain a partially untrained inference model. The first partial untraining procedure may reduce the prototype inference model's ability to generate responses based on an information content of the portion of the training data that is to be removed from the knowledge base of the prototype inference model. Performing the first partial untraining procedure may include: (i) placing weights of the prototype inference model in a mutable state, (ii) untraining the prototype inference model to reduce the prototype inference model's ability to generate responses based on the portion of the training data that is to be removed from the knowledge base (e.g., via a gradient ascent process with respect to inference error and resulting in modification of the weights) to obtain the partially untrained prototype inference model, (iii) freezing the weights of the partially untrained prototype inference model (e.g., by placing the weights in an immutable state thereby preventing the weights), and/or (iv) other methods.

The first partial untraining procedure may be performed via other methods without departing from embodiments disclosed herein.

At operation 322, a first testing procedure may be performed using the prototype inference model to determine whether the partially untrained prototype inference model provides inconsistent responses to a first set of prompts. Performing the first testing procedure may include: (i) obtaining, using a first set of prompts, a first set of responses from the partially untrained prototype inference model, the first set of responses including a first response to a first prompt of the first set of prompts and a second response to a second prompt of the second set of prompts, (ii) performing a response agreement testing process to obtain a level of agreement between at least the first response and the second response, (iii) determining whether the level of agreement meets agreement criteria, (iv) if the level of agreement meets agreement criteria, concluding that the partially untrained inference model provides the inconsistent responses to the first set of prompts, and/or (v) other methods. If the level of agreement does not meet the agreement criteria, it may be concluded that the partially untrained prototype inference model does not provide the inconsistent responses to the first set of prompts. Refer to FIG. 3C for additional details regarding performing the first testing procedure.

At operation 324, it may be determined whether the partially untrained prototype inference model provides the inconsistent responses to the first set of prompts. Determining whether the partially untrained inference model provides the inconsistent responses to the first set of prompts may include: (i) reading a result of the first testing procedure described in operation 322, (ii) receiving a notification from another entity responsible for performing the first testing procedure, and/or (iii) other methods.

If the partially untrained prototype inference model provides the inconsistent responses to the first set of prompts, the method may proceed to operation 326. If the partially untrained prototype inference model does not provide the inconsistent responses to the first set of prompts, the method may proceed to operation 332.

At operation 326, a second testing procedure may be performed to determine whether the partially untrained prototype inference model provides consistent and accurate responses to a second set of prompts. Performing the second testing procedure may include: (i) performing a first attempting to verify that the partially untrained prototype inference model provides consistent responses to the second set of prompts, (ii) if the partially untrained prototype inference model provides the consistent responses to the second set of prompts, performing a second attempting to verify that the partially untrained prototype inference model provides accurate responses to the second set of prompts using the second set of prompts, and/or (iii) other methods. If the partially untrained prototype inference model does not provide the consistent responses to the second set of prompts, it may be concluded that the partially untrained prototype inference model does not provide the consistent and accurate responses to the second set of prompts. Refer to FIG. 3D for additional details regarding performing the second testing procedure.

At operation 328, it may be determined whether the partially untrained prototype inference model provides the consistent and accurate responses to the second set of prompts. Determining whether the partially untrained prototype inference model provides the consistent and accurate responses to the second set of prompts may include: (i) reading a result of the second testing procedure described in operation 326, (ii) receiving a notification from another entity responsible for performing the second testing procedure, and/or (iii) other methods.

If the partially untrained prototype inference model provides the consistent and accurate responses to the second set of prompts, the method may proceed to operation 330.

At operation 330, it may be concluded that the partially untrained prototype inference model meets the performance criteria to obtain an updated prototype inference model. Concluding that the partially untrained prototype inference model meets the performance criteria may include: (i) concluding the partially untrained prototype inference model is sufficiently untrained (e.g., identifying that the untraining procedure is complete, not continuing to perform additional partial untraining procedures for the partially untrained prototype inference model), (ii) generating a data structure indicating that the partially untrained prototype inference model meets the performance criteria and is to be used as the updated prototype inference model, (iii) storing the data structure in a database and/or other storage architecture for retrieval when providing the computer-implemented services using the updated prototype inference model, (iv) notifying (e.g., via a message over a communication system, via a graphical user interface (GUI) on a device) another entity (e.g., the remote resource, the local resource, a downstream consumer) that the partially untrained prototype inference model meets the performance criteria, and/or (v) other methods.

The method may end following operation 330.

Returning to operation 328, the method may proceed to operation 332 if the partially untrained prototype inference model does not provide the consistent and accurate responses to the second set of prompts.

At operation 332, it may be concluded that the partially untrained prototype inference model does not meet the performance criteria. Concluding that the partially untrained prototype inference model does not meet the performance criteria may include: (i) concluding the partially untrained prototype inference model is not sufficiently untrained (e.g., identifying that the untraining procedure is not complete, marking the partially untrained prototype inference model for additional partial untraining procedures), (ii) generating a data structure indicating that the partially untrained prototype inference model does not meet the performance criteria, (iii) storing the data structure in a database and/or other storage architecture for retrieval when providing the computer-implemented services, (iv) notifying (e.g., via a message over a communication system, via a graphical user interface (GUI) on a device) another entity (e.g., the remote resource, the local resource, a downstream consumer) that the partially untrained prototype inference model does not meet the performance criteria, and/or (v) other methods.

The method may end following operation 332.

Returning to operation 324, the method may proceed to operation 332 if the partially untrained prototype inference model does not provide the inconsistent responses to the first set of prompts. At operation 332, it may be concluded that the partially untrained prototype inference model does not meet the performance criteria (see description of operation 332). In addition, a second partial untraining procedure may be performed for the partially untrained prototype inference model to obtain a further partially untrained prototype inference model. Performing the second partial untraining procedure may include methods similar to those described in operation 320 with respect to the first partial untraining procedure (e.g., a second gradient ascent process with respect to inference error and resulting in further modification of the weights). Refer to operation 310 in FIG. 3A for additional details regarding initiating the second partial untraining procedure. Following the second partial untraining procedure, additional testing processes may be performed to determine whether the further partially untrained inference model meets the performance criteria (e.g., similar to operations 322-332 of FIG. 3B).

Turning to FIG. 3C, a third flow diagram illustrating a method for performing a first testing procedure to determine whether a partially untrained prototype inference model provides inconsistent responses to a first set of prompts in accordance with an embodiment is shown. The method may be performed, for example, by any of the components of the system of FIG. 1, and/or any other entity without departing from embodiments disclosed herein. The operations shown in FIG. 3C may be an expansion of operation 322 in FIG. 3B.

At operation 350, a first set of responses may be obtained from the partially untrained prototype inference model using a set of prompts, the first set of responses including a first response to a first prompt of the first set of prompts and a second response to a second prompt of the first set of prompts. Obtaining the first set of responses may include: (i) obtaining the first set of prompts, (ii) feeding the first set of prompts to the partially untrained prototype inference model as ingest, (iii) receiving, in response to the first set of prompts, the first set of responses, and/or (iv) other methods. The first set of prompts may be adapted to elicit responses from inference models including sensitive information content from the portion of the training data used to train the prototype inference model and desired to be removed from the knowledge base of the prototype inference model.

Obtaining the first set of prompts may include: (i) reading the first set of prompts from storage, (ii) receiving the first set of prompts from another entity (e.g., via a transmission over a communication system), (iii) generating the first set of prompts, and/or (iv) other methods.

Generating the first set of prompts may include: (i) providing the portion of the training data to an inference model (e.g., the prototype inference model, a third inference model), (ii) prompting the inference model to generate the first set of prompts based on the portion of the training data which elicit responses including information content of the portion of the training data, (iii) obtaining an output from the inference model, the output including the first set of prompts and/or being usable to obtain the first set of prompts, and/or (iv) other methods.

At operation 352, a response agreement testing process may be performed to obtain a level of agreement between at least the first response and the second response. Performing the response agreement testing process may include: (i) prompting the prototype inference model and/or a third inference model to compare an information content of at least the first response and the second response, (ii) obtaining an output from the prototype inference model, the output being usable to obtain the level of agreement, and/or (iii) other methods.

Performing the response agreement testing process may also include obtaining the level of agreement. Obtaining the level of agreement may include: (i) parsing the output from the prototype inference model to identify the level of agreement from the output, (ii) performing an analysis process and/or a data processing process using the output from the prototype inference model to obtain the level of agreement, and/or (iii) other methods.

At operation 354, it may be determined whether the level of agreement meets agreement criteria. Determining whether the level of agreement meets the agreement criteria may include: (i) obtaining the agreement criteria (e.g., reading the agreement criteria from storage, receiving the agreement criteria from another entity, generating the agreement criteria), (ii) comparing a quantity of the level of agreement to a corresponding threshold quantity of the agreement criteria, and/or (iii) other methods. Determining whether the level of agreement meets the agreement criteria may also include providing the level of agreement and the agreement criteria to another entity responsible for comparing the level of agreement to the agreement criteria.

If it is determined that the level of agreement meets the agreement criteria, the method may proceed to operation 356.

At operation 356, it may be concluded that the partially untrained prototype inference model provides the inconsistent responses to the first set of prompts. Concluding that the partially untrained prototype inference model provides the inconsistent responses to the first set of prompts may include: (i) generating a data structure indicating that the partially untrained prototype inference model provides the inconsistent responses to the first set of prompts, (ii) storing the data structure in a database and/or other storage architecture, (iii) notifying (e.g., via a message over a communication system, via a graphical user interface (GUI) on a device) another entity (e.g., the remote resource, the local resource, a downstream consumer) that the partially untrained prototype inference model provides the inconsistent responses to the first set of prompts, and/or (iv) other methods.

The method may end following operation 356.

Returning to operation 354, the method may proceed to operation 358 if the level of agreement does not meet the agreement criteria. At operation 358, it may be concluded that the partially untrained prototype inference model does not provide the inconsistent responses to the first set of prompts (e.g., and, therefore, the partially untrained prototype inference model may provide consistent responses to the first set of prompts). Concluding that the partially untrained prototype inference model does not provide the inconsistent responses to the first set of prompts may include: (i) generating a data structure indicating that the partially untrained prototype inference model does not provide the inconsistent responses to the first set of prompts, (ii) storing the data structure in a database and/or other storage architecture, (iii) notifying (e.g., via a message over a communication system, via a GUI on a device) another entity (e.g., the remote resource, the local resource, a downstream consumer) that the partially untrained prototype inference model does not provide the inconsistent responses to the first set of prompts, and/or (iv) other methods.

The method may end following operation 358.

Turning to FIG. 3D, a fourth flow diagram illustrating a method for performing a second testing procedure to determine whether a partially untrained prototype inference model provides consistent and accurate responses to a second set of prompts in accordance with an embodiment is shown. The method may be performed, for example, by any of the components of the system of FIG. 1, and/or any other entity without departing from embodiments disclosed herein. The operations shown in FIG. 3D may be an expansion of operation 326 in FIG. 3B.

At operation 360, a first attempting to verify that the partially untrained prototype inference model provides the consistent responses to the second set of prompts may be performed. The second set of prompts may be based on other training data of the training data used to train the prototype inference model that is desired to be retained with the knowledge base of the prototype inference model. Performing the first attempting may include: (i) obtaining a second set of responses from the partially untrained prototype inference model using the second set of prompts, the second set of responses including a first response to a first prompt of the second set of prompts and a second response to a second prompt of the second set of prompts, (ii) performing a second response agreement testing process to obtain a second level of agreement between at least the first response and the second response, (iii) making a determination regarding whether the second level of agreement meets agreement criteria, (iv) in a first instance of the determination in which the second level of agreement meets the agreement criteria: concluding that the partially untrained prototype inference model provides the consistent responses to the second set of prompts, (v) in a second instance of the determination in which the second level of agreement does not meet the agreement criteria: concluding that the partially untrained prototype inference model does not provide the consistent responses to the second set of prompts, and/or (vi) other methods.

Obtaining the second set of responses may include methods similar to those described in operation 350 with respect to obtaining the first set of responses (e.g., obtaining the second set of prompts, feeding the second set of prompts to the partially untrained prototype inference model as ingest, receiving the second set of responses as output from the partially untrained prototype inference model).

The second agreement testing process may be similar to the agreement testing process described in operation 352 of FIG. 3C (e.g., prompting the prototype inference model and/or a third inference model to compare an information content of at least the first response and the second response, obtaining an output from the prototype inference model, the output being usable to obtain the second level of agreement).

Determining whether the second level of agreement meets the agreement criteria may include methods similar to those described in operation 354 of FIG. 3C (e.g., obtaining the agreement criteria, comparing a quantity of the second level of agreement to a corresponding threshold quantity of the agreement criteria).

Concluding that the partially untrained prototype inference model provides the consistent responses to the second set of prompts may be similar to operation 356 (e.g., generating a data structure indicating that the partially untrained prototype inference model provides the consistent responses, storing the data structure in a database, notifying another entity that the partially untrained prototype inference model provides the consistent responses).

Concluding that the partially untrained prototype inference model does not provide the consistent responses to the second set of prompts may be similar to operation 354 (e.g., generating a data structure indicating that the partially untrained prototype inference model does not provide the consistent responses, storing the data structure in a database, notifying another entity that the partially untrained prototype inference model does not provide the consistent responses).

At operation 362, it may be determined whether the partially untrained prototype inference model provides the consistent responses. Determining whether the partially untrained prototype inference model provides the consistent responses may include reading a result of the first attempting described in operation 360, obtaining a notification from another entity responsible for performing the first attempting, and/or other methods.

If it is determined that the partially untrained prototype inference model provides the consistent responses (e.g., the determination is “Yes” at operation 362), then the method may proceed to operation 364.

At operation 364, a second attempting to verify that the partially untrained prototype inference model provides the accurate responses to the second set of prompts may be performed. Performing the second attempting to verify may include: (i) comparing a first information content of the consistent responses (e.g., the second set of responses obtained in operation 360) to a second information content of other training data of the training data used to train the prototype inference model (e.g., training data that does not include the sensitive information and that is desired to be retained in the knowledge base) to obtain a level of similarity between the first information content and the second information content, (ii) making a determination regarding whether the level of similarity meets a level of similarity threshold, and/or (iii) other methods.

Comparing the first information content of the consistent responses to the second information content of the portion of the training data may include: (i) prompting the prototype inference model and/or a third inference model to compare the first information content and the second information content (e.g., providing the prototype inference model a prompt, the prompt including instructions for the prototype inference model to compare the first information content and the second information content), (ii) obtaining an output from the prototype inference model, the output being usable to obtain the level of similarity, and/or (iii) other methods.

Making a determination regarding whether the level of similarity meets the level of similarity threshold may include: (i) obtaining the level of similarity threshold (e.g., reading the level of similarity threshold from storage, receiving the level of similarity threshold from another entity, generating the level of similarity threshold), (ii) comparing a quantity of the level of similarity to a corresponding threshold quantity of the level of similarity threshold, and/or (iii) other methods. Determining whether the level of similarity meets the level of similarity threshold may also include providing the level of similarity and the level of similarity threshold to another entity responsible for comparing the level of similarity to the level of similarity threshold.

If the level of similarity meets the level of similarity threshold, it may be concluded that the partially untrained prototype inference model provides the accurate responses. Concluding that the partially untrained prototype inference model provides the accurate responses may include: (i) generating a data structure indicating that the partially untrained prototype inference model provides the accurate responses, (ii) storing the data structure in a database and/or other storage architecture for retrieval when determining whether the partially untrained prototype inference model meets performance criteria (refer to FIG. 3B), (iii) notifying (e.g., via a message over a communication system, via a graphical user interface (GUI) on a device) another entity (e.g., the remote resource, the local resource, a downstream consumer) that the partially untrained prototype inference model provides the accurate responses, and/or (iv) other methods.

If the level of similarity does not meet the level of similarity threshold, it may be concluded that the partially untrained prototype inference model does not provide the accurate responses. Concluding that the partially untrained prototype inference model does not provide the accurate responses may include: (i) generating a data structure indicating that the partially untrained prototype inference model does not provide the accurate responses, (ii) storing the data structure in a database and/or other storage architecture for retrieval when determining whether the partially untrained prototype inference model meets performance criteria (refer to FIG. 3B), (iii) notifying (e.g., via a message over a communication system, via a graphical user interface (GUI) on a device) another entity (e.g., the remote resource, the local resource, a downstream consumer) that the partially untrained prototype inference model does not provide the accurate responses, and/or (iv) other methods. If it is concluded that the partially untrained prototype inference model does not provide the accurate responses, a second partial untraining procedure may be performed for the prototype inference model. Refer to the description of operation 310 in FIG. 3A for additional details regarding performing the second partial untraining procedure.

The method may end following operation 364.

Returning to operation 362, the method may proceed to operation 366 if the partially untrained prototype inference model does not provide the consistent responses to the second set of prompts (e.g., the determination is “No”at operation 362).

At operation 366, it may be concluded that the partially untrained prototype inference model does not provide the consistent and accurate responses to the second set of prompts. Concluding that the partially untrained prototype inference model does not provide the consistent and accurate responses to the second set of prompts may include: (i) generating a data structure indicating that the partially untrained prototype inference model does not provide the consistent and accurate responses to the second set of prompts, (ii) storing the data structure in a database and/or other storage architecture, (iii) notifying (e.g., via a message over a communication system, via a GUI on a device) another entity (e.g., the remote resource, the local resource, a downstream consumer) that the partially untrained prototype inference model does not provide the consistent and accurate responses to the second set of prompts, and/or (iv) other methods.

The method may end following operation 366.

Thus, as illustrated above, embodiments disclosed herein may provide systems and methods usable to manage inference models so that a knowledge base of an inference model may be evaluated. The knowledge base of the inference model may be evaluated by evaluating an ability of the inference model to provide inconsistent responses to a first set of prompts based on a portion of training data and consistent and accurate responses to a second set of prompts based on other training data of the training data. By evaluating the inference model during untraining, an efficiency of untraining the inference model may be increased (e.g., via reduction of a resource cost) and a likelihood of providing the computer-implemented services as desired may be increased.

Any of the components illustrated in FIGS. 1-2H may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high-level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random-access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a Wi-Fi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as a SSD cache to enable non-volatile storage of context state and other such information during power down events so that a fast power up can occur on re-initiation of system activities. Also, a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs, or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for providing computer-implemented services using inference models, the method comprising:
identifying that a portion of training data used to train a prototype inference model has an information content that is to be removed from a knowledge base of the prototype inference model, the prototype inference model also having other information content based on other training data of the training data that is to be retained with the knowledge base of the prototype inference model;
initiating performance of an untraining procedure for the prototype inference model using at least the portion of the training data, a first set of prompts based on the portion of the training data, and a second set of prompts based on the other training data of the training data until performance criteria are met to obtain an updated prototype inference model, the performance criteria being usable to identify when the untraining procedure is complete and the performance criteria defining at least a first level of ability of the updated prototype inference model to utilize the information content to generate desirable responses to the first set of prompts and a second level of ability of the updated prototype inference model to utilize the other information content to generate desirable responses to the second set of prompts;
in a first instance of the initiating in which the performance criteria are met:
promoting the updated prototype inference model to a production ready inference model; and
using the production ready inference model to provide the computer-implemented services.

2. The method of claim 1, wherein initiating performance of the untraining procedure comprises:
performing, using the training data, a first partial untraining procedure for the prototype inference model to obtain a partially untrained prototype inference model;
performing, using the prototype inference model, a first testing procedure to determine whether the partially untrained prototype inference model provides inconsistent responses to the first set of prompts;
in a first instance of the performing the first testing procedure in which the partially untrained prototype inference model provides the inconsistent responses:
performing a second testing procedure to determine whether the partially untrained prototype inference model provides consistent and accurate responses to the second set of prompts; and
in a first instance of the performing the second testing procedure in which the partially untrained prototype inference model provides the consistent and accurate responses to the second set of prompts:
concluding that the partially untrained prototype inference model meets the performance criteria to obtain the updated prototype inference model.

3. The method of claim 2, further comprising:
in a second instance of the performing the first testing procedure in which the partially untrained prototype inference model does not provide the inconsistent responses to the first set of prompts:
performing a second partial untraining procedure for the partially untrained prototype inference model to obtain a further partially untrained prototype inference model.

4. The method of claim 2, wherein performing the first testing procedure comprises:
obtaining, using the first set of prompts, a first set of responses from the partially untrained prototype inference model, the first set of responses comprising:
a first response to a first prompt of the first set of prompts; and
a second response to a second prompt of the first set of prompts;
performing a response agreement testing process to obtain a level of agreement between at least the first response and the second response;
making a determination regarding whether the level of agreement meets agreement criteria;
in a first instance of the determination in which the level of agreement meets the agreement criteria:
concluding that the partially untrained prototype inference model provides the inconsistent responses to the first set of prompts; and
in a second instance of the determination in which the level of agreement does not meet the agreement criteria:
concluding that the partially untrained prototype inference model does not provide the inconsistent responses to the first set of prompts.

5. The method of claim 4, wherein providing the inconsistent responses to the first set of prompts indicates that a second knowledge base of the partially untrained prototype inference model does not have the information content.

6. The method of claim 2, wherein performing the second testing procedure comprises:
performing a first attempting to verify that the partially untrained prototype inference model provides the consistent responses to the second set of prompts; and
in a first instance of the first attempting where the partially untrained prototype inference model provides the consistent responses:
performing, using the second set of prompts, a second attempting to verify that the partially untrained prototype inference model provides the accurate responses to the second set of prompts.

7. The method of claim 6, wherein performing the first attempting comprises:
obtaining, using the second set of prompts, a second set of responses from the partially untrained prototype inference model, the second set of responses comprising:
a first response to a first prompt of the second set of prompts; and
a second response to a second prompt of the second set of prompts;
performing a second response agreement testing process to obtain a second level of agreement between at least the first response and the second response;
making a determination regarding whether the second level of agreement meets agreement criteria;
in a first instance of the determination in which the second level of agreement meets the agreement criteria:
concluding that the partially untrained prototype inference model provides the consistent responses to the second set of prompts; and
in a second instance of the determination in which the second level of agreement does not meet the agreement criteria:
concluding that the partially untrained prototype inference model does not provide the consistent responses to the second set of prompts.

8. The method of claim 7, wherein performing the second attempting comprises:
comparing a first information content of the consistent responses to the other information content of the other training data to obtain a level of similarity between the first information content and the other information content;
making a second determination regarding whether the level of similarity meets a level of similarity threshold;
in a first instance of the second determination in which the level of similarity meets the level of similarity threshold:
concluding that the partially untrained prototype inference model provides the accurate responses to the second set of prompts; and
in a second instance of the second determination in which the level of similarity does not meet the level of similarity threshold:
concluding that the partially untrained prototype inference model does not provide the accurate responses to the second set of prompts.

9. The method of claim 8, wherein providing the consistent and accurate responses to the second set of prompts indicates that a second knowledge base of the partially untrained prototype inference model has the other information content.

10. The method of claim 1, wherein the prototype inference model is a generative artificial intelligence (AI) model.

11. The method of claim 1, wherein the prototype inference model provides consistent and accurate responses to the first set of prompts and the second set of prompts.

12. A non-transitory machine-readable medium having instructions stored therein, which when executed by a processor, cause the processor to perform operations for providing computer-implemented services using inference models, the operations comprising:
identifying that a portion of training data used to train a prototype inference model has an information content that is to be removed from a knowledge base of the prototype inference model, the prototype inference model also having other information content based on other training data of the training data that is to be retained with the knowledge base of the prototype inference model;
initiating performance of an untraining procedure for the prototype inference model using at least the portion of the training data, a first set of prompts based on the portion of the training data, and a second set of prompts based on the other training data of the training data until performance criteria are met to obtain an updated prototype inference model, the performance criteria being usable to identify when the untraining procedure is complete and the performance criteria defining at least a first level of ability of the updated prototype inference model to utilize the information content to generate desirable responses to the first set of prompts and a second level of ability of the updated prototype inference model to utilize the other information content to generate desirable responses to the second set of prompts;
in a first instance of the initiating in which the performance criteria are met:
promoting the updated prototype inference model to a production ready inference model; and
using the production ready inference model to provide the computer-implemented services.

13. The non-transitory machine-readable medium of claim 12, wherein initiating performance of the untraining procedure comprises:
performing, using the training data, a first partial untraining procedure for the prototype inference model to obtain a partially untrained prototype inference model;
performing, using the prototype inference model, a first testing procedure to determine whether the partially untrained prototype inference model provides inconsistent responses to the first set of prompts;
in a first instance of the performing the first testing procedure in which the partially untrained prototype inference model provides the inconsistent responses:
performing a second testing procedure to determine whether the partially untrained prototype inference model provides consistent and accurate responses to the second set of prompts; and
in a first instance of the performing the second testing procedure in which the partially untrained prototype inference model provides the consistent and accurate responses to the second set of prompts:
concluding that the partially untrained prototype inference model meets the performance criteria to obtain the updated prototype inference model.

14. The non-transitory machine-readable medium of claim 13, wherein the operations further comprise:
in a second instance of the performing the first testing procedure in which the partially untrained prototype inference model does not provide the inconsistent responses to the first set of prompts:
performing a second partial untraining procedure for the partially untrained prototype inference model to obtain a further partially untrained prototype inference model.

15. The non-transitory machine-readable medium of claim 13, wherein performing the first testing procedure comprises:
obtaining, using the first set of prompts, a first set of responses from the partially untrained prototype inference model, the first set of responses comprising:
a first response to a first prompt of the first set of prompts; and
a second response to a second prompt of the first set of prompts;
performing a response agreement testing process to obtain a level of agreement between at least the first response and the second response;
making a determination regarding whether the level of agreement meets agreement criteria;
in a first instance of the determination in which the level of agreement meets the agreement criteria:
concluding that the partially untrained prototype inference model provides the inconsistent responses to the first set of prompts; and
in a second instance of the determination in which the level of agreement does not meet the agreement criteria:
concluding that the partially untrained prototype inference model does not provide the inconsistent responses to the first set of prompts.

16. The non-transitory machine-readable medium of claim 15, wherein providing the inconsistent responses to the first set of prompts indicates that a second knowledge base of the partially untrained prototype inference model does not have the information content.

17. A data processing system, comprising:
a processor; and
a memory coupled to the processor to store instructions, which when executed by the processor, cause the processor to perform operations for providing computer-implemented services using inference models, the operations comprising:
identifying that a portion of training data used to train a prototype inference model has an information content that is to be removed from a knowledge base of the prototype inference model, the prototype inference model also having other information content based on other training data of the training data that is to be retained with the knowledge base of the prototype inference model;
initiating performance of an untraining procedure for the prototype inference model using at least the portion of the training data, a first set of prompts based on the portion of the training data, and a second set of prompts based on the other training data of the training data until performance criteria are met to obtain an updated prototype inference model, the performance criteria being usable to identify when the untraining procedure is complete and the performance criteria defining at least a first level of ability of the updated prototype inference model to utilize the information content to generate desirable responses to the first set of prompts and a second level of ability of the updated prototype inference model to utilize the other information content to generate desirable responses to the second set of prompts;
in a first instance of the initiating in which the performance criteria are met:
promoting the updated prototype inference model to a production ready inference model; and
using the production ready inference model to provide the computer-implemented services.

18. The data processing system of claim 17, wherein initiating performance of the untraining procedure comprises:
performing, using the training data, a first partial untraining procedure for the prototype inference model to obtain a partially untrained prototype inference model;
performing, using the prototype inference model, a first testing procedure to determine whether the partially untrained prototype inference model provides inconsistent responses to the first set of prompts;
in a first instance of the performing the first testing procedure in which the partially untrained prototype inference model provides the inconsistent responses:
performing a second testing procedure to determine whether the partially untrained prototype inference model provides consistent and accurate responses to the second set of prompts; and
in a first instance of the performing the second testing procedure in which the partially untrained prototype inference model provides the consistent and accurate responses to the second set of prompts:
concluding that the partially untrained prototype inference model meets the performance criteria to obtain the updated prototype inference model.

19. The data processing system of claim 18, wherein the operations further comprise:
in a second instance of the performing the first testing procedure in which the partially untrained prototype inference model does not provide the inconsistent responses to the first set of prompts:
performing a second partial untraining procedure for the partially untrained prototype inference model to obtain a further partially untrained prototype inference model.

20. The data processing system of claim 18, wherein performing the first testing procedure comprises:
obtaining, using the first set of prompts, a first set of responses from the partially untrained prototype inference model, the first set of responses comprising:
a first response to a first prompt of the first set of prompts; and
a second response to a second prompt of the first set of prompts;
performing a response agreement testing process to obtain a level of agreement between at least the first response and the second response;
making a determination regarding whether the level of agreement meets agreement criteria;
in a first instance of the determination in which the level of agreement meets the agreement criteria:
concluding that the partially untrained prototype inference model provides the inconsistent responses to the first set of prompts; and
in a second instance of the determination in which the level of agreement does not meet the agreement criteria:
concluding that the partially untrained prototype inference model does not provide the inconsistent responses to the first set of prompts.
